(19) United States
(12) Patent Application Publication
(10) Pub. No.: US 2026/0039348 A1
(43) Pub. Date: Feb. 5, 2026

(54) TYPE-II-COHERENT JOINT TRANSMISSION CHANNEL STATE INFORMATION REPORTING WITH FREQUENCY DOMAIN COMPENSATION AT A FINER THAN SUBBAND SIZE LEVEL

(71) Applicant: QUALCOMM Incorporated, San Diego, CA (US)

(72) Inventors: Jing Dai, Beijing (CN); Liangming Wu, Beijing (CN); Chenxi Hao, Beijing (CN); Wei Xi, Beijing (CN); Min Huang, Beijing (CN); Chao Wei, Beijing (CN); Hao Xu, Beijing (CN)

(21) Appl. No.: 19/100,840

(22) PCT Filed: Sep. 22, 2022
(86) PCT No.: PCT/CN2022/120408

§ 371 Date: Feb. 3, 2025

(51) Int. Cl. H04B 7/06; H04W 72/0453

(52) U.S. Cl. CPC H04B 7/0626; H04B 7/06968; H04W 72/0453

(57) ABSTRACT

This disclosure provides systems, methods, and devices for wireless communication that support coherent joint transmission (CJT) channel state information (CSI) reporting with frequency domain (FD) compensation at a finer than subband size level. In a first aspect, a method of wireless communication includes a user equipment (UE) determining a plurality of CSI parameters for a set of N TRP transmission-reception points (TRPs). The UE may identify a reference TRP, calculate FD compensation for each FD compensation unit to compensate a precoder to each non-reference TRP and corresponds to a delay difference between the each non-reference TRP and the reference TRP. The UE then transmits a CSI report including the FD compensated precoder for each FD compensation unit, wherein the CSI report includes the precoder applicable to a total number of reported TRPs fewer than N_{TRP}−1. Other aspects and features are also claimed and described.

### TECHNICAL FIELD

Aspects of the present disclosure relate generally to wireless communication systems, and more particularly, to coherent joint transmission (CJT) 5G next radio (NR) communications. Some features may enable and provide improved communications, including Type-II CJT channel state information (CSI) reporting with frequency domain compensation at a finer than subband size level.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as network entities base stations (e.g., base stations or node Bs) that may support communication for a number of user equipments (UEs). A UE may communicate with a network entity via downlink and uplink. The downlink (or forward link) refers to the communication link from the network entity to the UE, and the uplink (or reverse link) refers to the communication link from the UE to the network entity.

A network entity may transmit data and control information on a downlink to a UE or may receive data and control information on an uplink from the UE. On the downlink, a transmission from the network entity may encounter interference due to transmissions from neighbor network entities or from other wireless radio frequency (RF) transmitters. On the uplink, a transmission from the UE may encounter interference from uplink transmissions of other UEs communicating with the neighbor network entities or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication by a user equipment (UE) configured with coherent joint transmission (CJT) multi-transmission-reception point (mTRP) channel state information (CSI) reporting. The method includes determining a plurality of CSI parameters from measurement of one or more channel conditions of CSI-reference signals (CSI-RS) received from a set of N_{TRP} transmission-reception points (TRPs), wherein N_{TRP} corresponds to a number of TRPs within the set of N_{TRP} TRPs, identifying a reference TRP of the set of N_{TRP} TRPs, calculating a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP, and transmitting a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

In an additional aspect of the disclosure, an apparatus configured for wireless communication is disclosed. The apparatus includes at least one processor, and a memory coupled to the at least one processor. The at least one processor is configured to determine a plurality of CSI parameters from measurement of one or more channel conditions of CSI-RS received from a set of N_{TRP} TRPs, wherein N_{TRP} corresponds to a number of TRPs within the set of N_{TRP} TRPs, identify a reference TRP of the set of N_{TRP} TRPs, calculate a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP, and transmit a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

In an additional aspect of the disclosure, an apparatus configured for wireless communication is disclosed. The apparatus includes means for determining a plurality of CSI parameters from measurement of one or more channel conditions of CSI-RS received from a set of N_{TRP} TRPs, wherein N_{TRP} corresponds to a number of TRPs within the set of N_{TRP} TRPs, means for identifying a reference TRP of the set of N_{TRP} TRPs, means for calculating a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP, and means for transmitting a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

In an additional aspect of the disclosure, a non-transitory computer-readable medium stores instructions that, when executed by a processor, cause the processor to perform operations including determining a plurality of CSI parameters from measurement of one or more channel conditions of CSI-RS received from a set of N_{TRP} TRPs, wherein N_{TRP} corresponds to a number of TRPs within the set of N_{TRP} TRPs, identifying a reference TRP of the set of N_{TRP} TRPs, calculating a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP, and transmitting a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system that would support Type-II coherent joint transmission (CJT) channel state information (CSI) reporting with frequency domain compensation at a finer than subband size level according to one or more aspects.

FIG. 2 is a block diagram illustrating examples of a base station and a user equipment (UE) according to one or more aspects.

FIG. 3 is a block diagram illustrating a wireless network that would support Type-II CJT CSI reporting with frequency domain compensation at a finer than subband size level according to one or more aspects.

FIG. 4 is a flow diagram illustrating an example process that supports Type-II CJT CSI reporting with frequency domain compensation at a finer than subband size level according to one or more aspects.

FIGS. 5A and 5B are block diagrams illustrating wireless networks configured with network entities and a UE configured to support Type-II CJT CSI reporting with frequency domain compensation at a finer than subband size level according to one or more aspects.

FIG. 6 is a block diagram illustrating a wireless network configured with network entities and a UE configured to support Type-II CJT CSI reporting with frequency domain compensation at a finer than subband size level according to one or more aspects.

FIG. 7 is a block diagrams illustrating a wireless network configured with network entities and a UE configured to support Type-II CJT CSI reporting with frequency domain compensation at a finer than subband size level according to one or more aspects.

FIG. 8 is a block diagrams illustrating a wireless network configured with network entities and a UE configured to support Type-II CJT CSI reporting with frequency domain compensation at a finer than subband size level according to one or more aspects.

FIG. 9 is a block diagram illustrating a wireless network configured with network entities and a UE configured to support Type-II CJT CSI reporting with frequency domain compensation at a finer than subband size level according to one or more aspects.

FIG. 10 is a block diagram of an example UE that supports Type-II CJT CSI reporting with frequency domain compensation at a finer than subband size level according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support Type-II CJT CSI reporting with frequency domain compensation at a finer than subband size level. Particular implementations of the subject matter described in this disclosure may be implemented to realize one or more of the following potential advantages or benefits. In some aspects, the present disclosure provides techniques for Type-II CJT CSI reporting with frequency domain compensation at a finer than subband size level. The various aspects of the present disclosure may extend the Type-II codebook to include CJT for multiple TRP where frequency domain (FD) compensation may be targeted for feedback. The disclosed aspects allow effective quantization of the FD compensation and define how to assemble the CSI report in order to increase the reliability of higher priority FD compensation information being transmitted.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “mmW” band.

The frequencies between FR1 and FR2 are often referred to as mid-band frequencies. Recent 5G NR studies have identified an operating band for these mid-band frequencies as frequency range designation FR3 (7.126 GHz-24.25 GHz). Frequency bands falling within FR3 may inherit FR1 characteristics and/or FR2 characteristics, and, thus, may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2x (52.6 GHz-71 GHz), FR4 (71 GHz-114.25 GHz), and FR5 (114.25 GHz-275 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmW” or the like if used herein may broadly represent frequencies that may include mid-band frequencies, may be within FR2, FR2x, FR4, and/or FR5, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmW transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmW components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level (e.g., or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

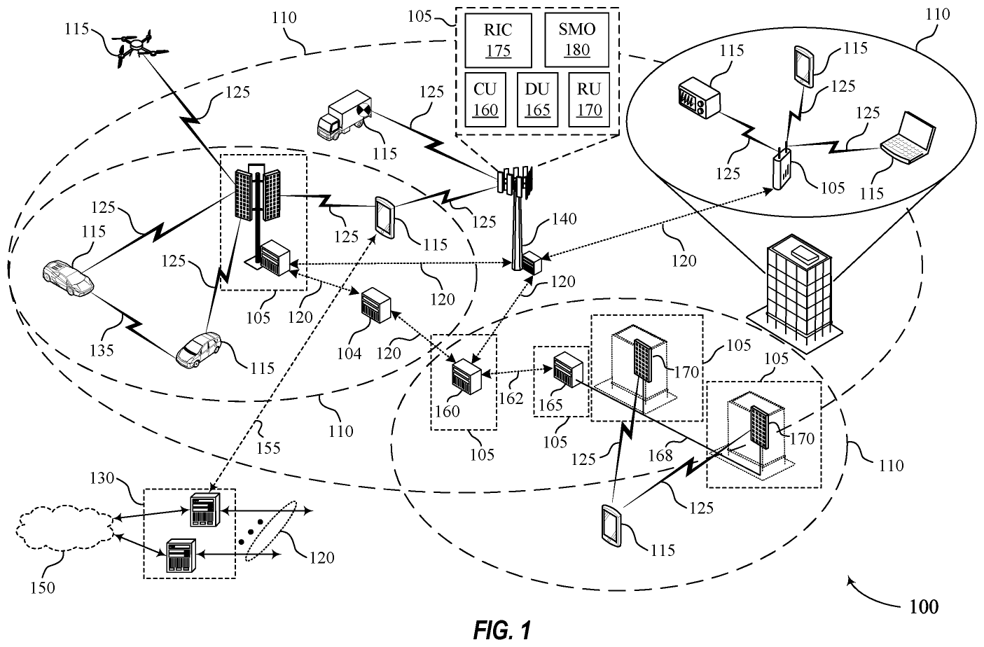

FIG. 1 illustrates an example of a wireless communications system 100 that supports scheduling requests for spatial multiplexing in accordance with one or more aspects of the present disclosure. Wireless communications system 100 may include one or more network entities 105, one or more UEs 115, and a core network 130. In some examples, wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

Network entities 105 may be dispersed throughout a geographic area to form wireless communications system 100 and may include devices in different forms or having different capabilities. In 3GPP, the term “cell” may refer to this particular geographic coverage area of a network entity, such as network entities 105, or a network entity subsystem serving the coverage area, depending on the context in which the term is used. In various examples, network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, network entity 105 may support a coverage area 110 (e.g., a geographic coverage area) over which UEs 115 and network entity 105 may establish one or more communication links 125. Coverage area 110 may be an example of a geographic area over which network entity 105 and UE 115 may support the communication of signals according to one or more radio access technologies (RATs).

UEs 115 may be dispersed throughout coverage area 110 of the wireless communications system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115 or network entities 105, as shown in FIG. 1.

As described herein, a node of wireless communications system 100, which may be referred to as a network node, or a wireless node, may be network entity 105 (e.g., any network entity described herein), UE 115 (e.g., any UE described herein), a network controller, an apparatus, a device, a computing system, one or more components, or another suitable processing entity configured to perform any of the techniques described herein. For example, a node may be UE 115. As another example, a node may be network entity 105. As another example, a first node may be configured to communicate with a second node or a third node. In one aspect of this example, the first node may be UE 115, the second node may be network entity 105, and the third node may be UE 115. In another aspect of this example, the first node may be UE 115, the second node may be network entity 105, and the third node may be network entity 105. In yet other aspects of this example, the first, second, and third nodes may be different relative to these examples. Similarly, reference to UE 115, network entity 105, apparatus, device, computing system, or the like may include disclosure of UE 115, network entity 105, apparatus, device, computing system, or the like being a node. For example, disclosure that UE 115 is configured to receive information from network entity 105 also discloses that a first node is configured to receive information from a second node.

In some examples, network entities 105 may communicate with core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over backhaul communication link 120 (e.g., in accordance with an X2, Xn, or other interface protocol) either directly (e.g., directly between network entities 105) or indirectly (e.g., via core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. Backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. UE 115 may communicate with core network 130 through a communication link 155.

One or more of network entities 105 described herein may include or may be referred to as base station 140 (e.g., a base transceiver station, a radio base station, an NR base station, an access point, a radio transceiver, a transmission-reception point (TRP), a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, network entity 105 (e.g., base station 140) may be implemented in an aggregated (e.g., monolithic, standalone) base station architecture, which may be configured to utilize a protocol stack that is physically or logically integrated within a single network entity 105 (e.g., a single RAN node, such as base station 140).

In some examples, network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. RU 170 may also be referred to as a radio head, a smart radio head, a remote radio head (RRH), a remote radio unit (RRU), or a transmission reception point (TRP). One or more components of network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between CU 160, DU 165, and RU 175 is flexible and may support different functionalities depending upon which functions (e.g., network layer functions, protocol layer functions, baseband functions, RF functions, and any combinations thereof) are performed at CU 160, DU 165, or RU 175. For example, a functional split of a protocol stack may be employed between CU 160 and DU 165 such that CU 160 may support one or more layers of the protocol stack and DU 165 may support one or more different layers of the protocol stack. In some examples, CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). CU 160 may be connected to one or more DUs 165 or RUs 170, and one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by CU 160.

Additionally, or alternatively, a functional split of the protocol stack may be employed between DU 165 and RU 170 such that DU 165 may support one or more layers of the protocol stack and RU 170 may support one or more different layers of the protocol stack. DU 165 may support one or multiple different cells (e.g., via one or more RUs 170). In some cases, a functional split between CU 160 and DU 165, or between DU 165 and RU 170 may be within a protocol layer (e.g., some functions for a protocol layer may be performed by one of CU 160, DU 165, or RU 170, while other functions of the protocol layer are performed by a different one of CU 160, DU 165, or RU 170). CU 160 may be functionally split further into CU control plane (CU-CP) and CU user plane (CU-UP) functions. CU 160 may be connected to one or more DUs 165 via midhaul communication link 162 (e.g., F1, F1-c, F1-u), and DU 165 may be connected to one or more RUs 170 via fronthaul communication link 168 (e.g., open fronthaul (FH) interface). In some examples, midhaul communication link 162 or fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of RU 170) of IAB node 104 used for access via DU 165 of IAB node 104 (e.g., referred to as virtual IAB-MT (vIAB-MT)). In some examples, IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between core network 130 and the AN (e.g., via a wired or wireless connection to core network 130). That is, an IAB donor may refer to a RAN node with a wired or wireless connection to core network 130. The IAB donor may include CU 160 and at least one DU 165 (e.g., and RU 170), in which case CU 160 may communicate with core network 130 over an interface (e.g., a backhaul link). IAB donor and IAB nodes 104 may communicate over an F1 interface according to a protocol that defines signaling messages (e.g., an F1 AP protocol). Additionally, or alternatively, CU 160 may communicate with the core network over an interface, which may be an example of a portion of backhaul link, and may communicate with other CUs 160 (e.g., CU 160 associated with an alternative IAB donor) over an Xn-C interface, which may be an example of a portion of a backhaul link.

IAB node 104 may refer to a RAN node that provides IAB functionality (e.g., access for UEs 115, wireless self-backhauling capabilities). DU 165 may act as a distributed scheduling node towards child nodes associated with IAB node 104, and the IAB-MT may act as a scheduled node towards parent nodes associated with IAB node 104. That is, an IAB donor may be referred to as a parent node in communication with one or more child nodes (e.g., an IAB donor may relay transmissions for UEs through one or more other IAB nodes 104). Additionally, or alternatively, IAB node 104 may also be referred to as a parent node or a child node to other IAB nodes 104, depending on the relay chain or configuration of the AN. Therefore, the IAB-MT entity of IAB nodes 104 may provide a Uu-interface for a child IAB node 104 to receive signaling from parent IAB node 104, and the DU interface (e.g., DUs 165) may provide a Uu-interface for parent IAB node 104 to signal to child IAB node 104 or UE 115.

For example, IAB node 104 may be referred to as a parent node that supports communications for a child IAB node, and referred to as a child IAB node associated with an IAB donor. The IAB donor may include CU 160 with a wired or wireless connection (e.g., backhaul communication link 120) to core network 130 and may act as parent node to IAB nodes 104. For example, DU 165 of IAB donor may relay transmissions to UEs 115 through IAB nodes 104, and may directly signal transmissions to UE 115. CU 160 of IAB donor may signal communication link establishment via an F1 interface to IAB nodes 104, and IAB nodes 104 may schedule transmissions (e.g., transmissions to UEs 115 relayed from the IAB donor) through DUs 165. That is, data may be relayed to and from IAB nodes 104 via signaling over an NR Uu-interface to MT of IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support scheduling requests for spatial multiplexing as described herein. For example, some operations described as being performed by UE 115 or network entity 105 (e.g., base station 140) may additionally, or alternatively, be performed by one or more components of the disaggregated RAN architecture (e.g., IAB nodes 104, DUs 165, CUs 160, RUs 170, RIC 175, SMO 180).

UE 115 may include or may be referred to as a mobile device, a wireless device, a remote device, a handheld device, or a subscriber device, or some other suitable terminology, where the “device” may also be referred to as a unit, a station, a terminal, or a client, among other examples. UE 115 may also include or may be referred to as a personal electronic device such as a cellular phone, a personal digital assistant (PDA), a tablet computer, a laptop computer, or a personal computer. In some examples, UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, a satellite radio, a global positioning system (GPS) device, a global navigation satellite system (GNSS) device, a logistics controller, an unmanned aerial vehicle (UAV), a drone, a smart energy or security device, a solar panel or solar array, etc. among other examples.

UEs 115 described herein may be able to communicate with various types of devices, such as other UEs 115 that may sometimes act as relays as well as network entities 105 and the network equipment including macro eNBs or gNBs, small cell eNBs or gNBs, or relay base stations, among other examples, as shown in FIG. 1.

UEs 115 and network entities 105 may wirelessly communicate with one another via one or more communication links 125 (e.g., an access link) over one or more carriers. The term “carrier” may refer to a set of RF spectrum resources having a defined physical layer structure for supporting communication links 125. For example, a carrier used for communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communications system 100 may support communication with UE 115 using carrier aggregation or multi-carrier operation. UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between network entity 105 and other devices may refer to communication between the devices and any portion (e.g., entity, sub-entity) of network entity 105. For example, the terms “transmitting,” “receiving,” or “communicating,” when referring to network entity 105, may refer to any portion of network entity 105 (e.g., base station 140, CU 160, DU 165, RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with UE 115.

One or more numerologies for a carrier may be supported, where a numerology may include a subcarrier spacing (Δf) and a cyclic prefix. A carrier may be divided into one or more BWPs having the same or different numerologies. In some examples, UE 115 may be configured with multiple BWPs. In some examples, a single BWP for a carrier may be active at a given time and communications for UE 115 may be restricted to one or more active BWPs.

The time intervals for network entities 105 or UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of UEs 115. For example, one or more of UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific one of UEs 115.

In some examples, network entity 105 (e.g., base station 140, RU 170) may be movable and therefore provide communication coverage for a moving one of coverage areas 110. In some examples, a different one of coverage areas 110 associated with different technologies may overlap, but the different one of coverage areas 110 may be supported by the same one of network entities 105. In some other examples, the overlapping coverage areas 110 associated with different technologies may be supported by different ones of network entities 105. Wireless communications system 100 may include, for example, a heterogeneous network in which different types of network entities 105 provide coverage for various coverage areas 110 using the same or different radio access technologies.

Some of UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or network entity 105 (e.g., base station 140) without human intervention. In some examples, M2M communication or MTC may include communications from devices that integrate sensors or meters to measure or capture information and relay such information to a central server or application program that makes use of the information or presents the information to humans interacting with the application program. Some of UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some of UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for UEs 115 include entering a power saving deep sleep mode when not engaging in active communications, operating over a limited bandwidth (e.g., according to narrowband communications), or a combination of these techniques. For example, some of UEs 115 may be configured for operation using a narrowband protocol type that is associated with a defined portion or range (e.g., set of subcarriers or resource blocks (RBs)) within a carrier, within a guard-band of a carrier, or outside of a carrier.

Wireless communications system 100 may be configured to support ultra-reliable communications or low-latency communications, or various combinations thereof. For example, wireless communications system 100 may be configured to support ultra-reliable low-latency communications (URLLC). UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within coverage area 110 of network entity 105 (e.g., base station 140, RU 170), which may support aspects of such D2D communications being configured by or scheduled by network entity 105. In some examples, one or more UEs 115 in such a group may be outside coverage area 110 of network entity 105 or may be otherwise unable to or not configured to receive transmissions from network entity 105. In some examples, groups of UEs 115 communicating via D2D communications may support a one-to-many (1:M) system in which each UE 115 transmits to each of the other ones of UEs 115 in the group. In some examples, network entity 105 may facilitate the scheduling of resources for D2D communications. In some other examples, D2D communications may be carried out between UEs 115 without the involvement of network entity 105.

In some systems, D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

Core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 served by network entities 105 (e.g., base stations 140) associated with core network 130. User IP packets may be transferred through the user plane entity, which may provide IP address allocation as well as other functions. The user plane entity may be connected to IP services 150 for one or more network operators. IP services 150 may include access to the Internet, Intranet(s), an IP Multimedia Subsystem (IMS), or a Packet-Switched Streaming Service.

Wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between UEs 115 and network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

Wireless communications system 100 may utilize both licensed and unlicensed RF spectrum bands. For example, wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as network entities 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

Network entity 105 (e.g., base station 140, RU 170) or UE 115 may be equipped with multiple antennas, which may be used to employ techniques such as transmit diversity, receive diversity, multiple-input multiple-output (MIMO) communications, or beamforming. The antennas of network entity 105 or UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with network entity 105 may be located in diverse geographic locations. Network entity 105 may have an antenna array with a set of rows and columns of antenna ports that network entity 105 may use to support beamforming of communications with UE 115. Likewise, UE 115 may have one or more antenna arrays that may support various MIMO or beamforming operations. Additionally, or alternatively, an antenna panel may support RF beamforming for a signal transmitted via an antenna port.

Network entities 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., network entity 105, UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Network entity 105 or UE 115 may use beam sweeping techniques as part of beamforming operations. For example, network entity 105 (e.g., base station 140, RU 170) may use multiple antennas or antenna arrays (e.g., antenna panels) to conduct beamforming operations for directional communications with UE 115. Some signals (e.g., synchronization signals, reference signals, beam selection signals, or other control signals) may be transmitted by network entity 105 multiple times along different directions. For example, network entity 105 may transmit a signal according to different beamforming weight sets associated with different directions of transmission. Transmissions along different beam directions may be used to identify (e.g., by a transmitting device, such as network entity 105, or by a receiving device, such as UE 115) a beam direction for later transmission or reception by network entity 105.

Some signals, such as data signals associated with a particular receiving device, may be transmitted by a transmitting device (e.g., transmitting network entity 105, transmitting UE 115) along a single beam direction (e.g., a direction associated with the receiving device, such as receiving network entity 105 or receiving UE 115). In some examples, the beam direction associated with transmissions along a single beam direction may be determined based on a signal that was transmitted along one or more beam directions. For example, UE 115 may receive one or more of the signals transmitted by network entity 105 along different directions and may report to network entity 105 an indication of the signal that UE 115 received with a highest signal quality or an otherwise acceptable signal quality.

In some examples, transmissions by a device (e.g., by network entity 105 or UE 115) may be performed using multiple beam directions, and the device may use a combination of digital precoding or beamforming to generate a combined beam for transmission (e.g., from network entity 105 to UE 115). The UE 115 may report feedback that indicates precoding weights for one or more beam directions, and the feedback may correspond to a configured set of beams across a system bandwidth or one or more sub-bands. Network entity 105 may transmit a reference signal (e.g., a cell-specific reference signal (CRS), a channel state information reference signal (CSI-RS)), which may be precoded or unprecoded. UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by network entity 105 (e.g., base station 140, RU 170), UE 115 may employ similar techniques for transmitting signals multiple times along different directions (e.g., for identifying a beam direction for subsequent transmission or reception by UE 115) or for transmitting a signal along a single direction (e.g., for transmitting data to a receiving device).

A receiving device (e.g., UE 115) may perform reception operations in accordance with multiple receive configurations (e.g., directional listening) when receiving various signals from a receiving device (e.g., network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between UE 115 and network entity 105 or core network 130 supporting radio bearers for user plane data. At the PHY layer, transport channels may be mapped to physical channels.

UEs 115 and network entities 105 may support retransmissions of data to increase the likelihood that data is received successfully. Hybrid automatic repeat request (HARQ) feedback is one technique for increasing the likelihood that data is received correctly over a communication link (e.g., communication link 125, D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

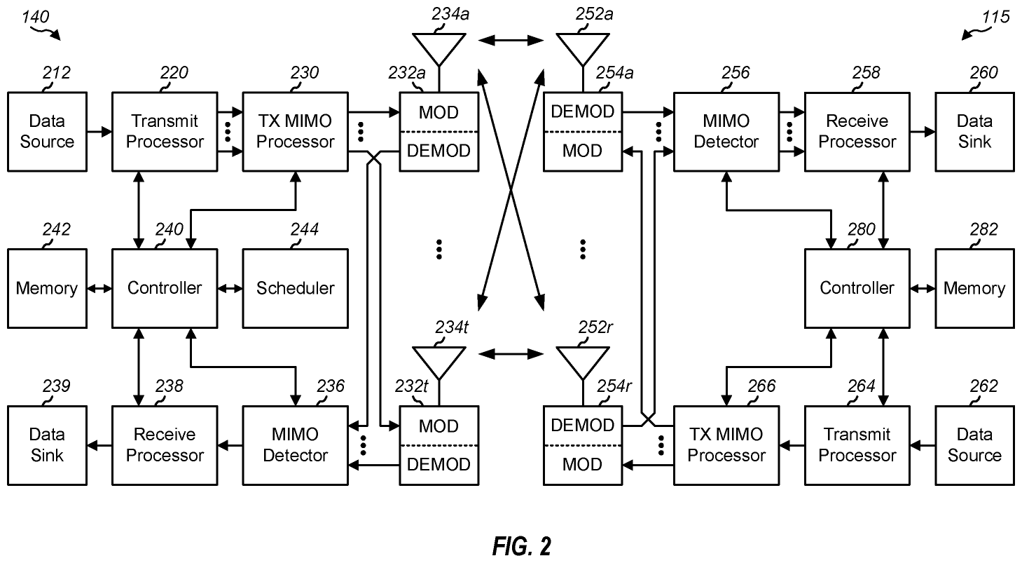

FIG. 2 is a block diagram illustrating examples of base station 140 and UE 115 according to one or more aspects. Base station 140 and UE 115 may be any of the network entities and base stations and one of the UEs in FIG. 1. For a restricted association scenario (as mentioned above), network entity 105 may be small cell base station, and UE 115 may be UE 115 operating in a service area of the small cell base station, which in order to access the small cell base station, would be included in a list of accessible UEs for the small cell base station. Base station 140 may also be a base station of some other type. As shown in FIG. 2, a network entity 105, such as base station 140 may be equipped with antennas 234a through 234t, and UE 115 may be equipped with antennas 252a through 252r for facilitating wireless communications.

At base station 140, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 140 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to network entity 105. At network entity 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

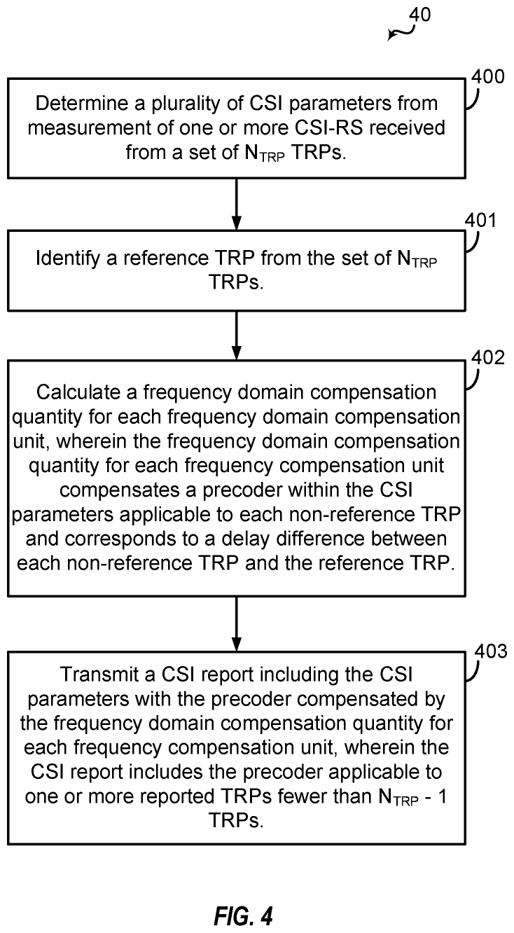

Controllers 240 and 280 may direct the operation at base station 140 and UE 115, respectively. Controller 240 or other processors and modules at base station 140 or controller 280 or other processors and modules at UE 115 may perform or direct the execution of various processes for the techniques described herein, such as to perform or direct the execution illustrated in FIG. 4, or other processes for the techniques described herein. Memories 242 and 282 may store data and program codes for base station 140 and UE 115, respectively. Scheduler 244 may schedule UEs for data transmission on the downlink or the uplink.

In some cases, UE 115 and base station 140 may operate in a shared radio frequency spectrum band, which may include licensed or unlicensed (e.g., contention-based) frequency spectrum. In an unlicensed frequency portion of the shared radio frequency spectrum band, UEs 115 or base station 140 may traditionally perform a medium-sensing procedure to contend for access to the frequency spectrum. For example, UE 115 or base station 140 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, a 16-μs, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Sensing for shared channel access may also be categorized into either full-blown or abbreviated types of LBT procedures. For example, a full LBT procedure, such as a CAT 3 or CAT 4 LBT procedure, including extended channel clearance assessment (ECCA) over a non-trivial number of 9-μs slots, may also be referred to as a “Type 1 LBT.” An abbreviated LBT procedure, such as a CAT 2 LBT procedure, which may include a one-shot CCA for 16-μs or 25-μs, may also be referred to as a “Type 2 LBT.”

Use of a medium-sensing procedure to contend for access to an unlicensed shared spectrum may result in communication inefficiencies. This may be particularly evident when multiple network operating entities (e.g., network operators) are attempting to access a shared resource. In wireless communications system 100, network entities 105 and UEs 115 may be operated by the same or different network operating entities. In some examples, an individual network entity 105 or UE 115 may be operated by more than one network operating entity. In other examples, each network entity 105 and UE 115 may be operated by a single network operating entity. Requiring each network entity 105 and UE 115 of different network operating entities to contend for shared resources may result in increased signaling overhead and communication latency.

In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In advanced wireless communications, including 5G NR, joint transmission defines the concurrent data transmission from multiple coordinated network entities to a UE. Joint transmission may be implemented as coherent joint transmission (CJT) or non-coherent joint transmission (NCJT). In the case of CJT, the network would have some knowledge of the detailed channels to the UE from the two or more network entities, such as, for example, transmission-reception points (TRPs), involved in the joint transmission. The network may then select transmission weights accordingly, such as, to focus the energy at the position of the UE. Thus, CJT can be seen similarly to a type of pseudo beam-forming for which the antenna panels taking part in the beam-forming may not be collocated, but may correspond to different TRPs. In contrast, for NCJT, the network does not make use of any detailed channel knowledge in the joint transmission.

Rel-16 eType-II CSI reporting includes determination of a precoder according to the general equation:

$$W = {W}_{1} \times {\tilde{W}}_{2} \times {W}_{f}^{H} \qquad ( 1 )$$

NCJT communications may precode data separately on different TRPs. The NCJT precoder,

$$W = [ \begin{matrix}{V}_{A} & 0 \\ 0 & {V}_{B}\end{matrix} ]$$

(assuming two TRPs, TRP_{A} and TRP_{B}) identifies the separate precoders which may then be applied to the data (X_{A} and X_{B}) at each of TRP_{A} and TRP_{B} according to the equation:

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] \qquad ( 2 )$$

Where the precoders satisfy

$$( {N}_{t}^{TRP} \times {RI}^{TRP} ) {V}_{A} : 4 \times 1 , {V}_{B} : 4 \times 2 , and data ( {RI}^{T R P} \times 1 )$$

X_{A}: 1×1, X_{B}: 2×1. With the separate precoding, a UE may identify which data is transmitted from which TRP.

In contrast, CJT communications may precode data from all TRPs (e.g., TRP_{A} and TRP_{B}) jointly. The CJT precoder,

$$W = [ \begin{matrix}{V}_{A} \\ {V}_{B}\end{matrix} ]$$

(assuming the two TRPs, TRP_{A} and TRP_{B}) reflects the joint precoding which may then be applied to the data (X_{A} and X_{B}) at each of TRP_{A} and TRP_{B} according to the equation:

$$[ \begin{matrix}{V}_{A} \\ {V}_{B}\end{matrix} ] \cdot X = [ \begin{matrix}{V}_{A} X \\ {V}_{B} X\end{matrix} ] \qquad ( 3 )$$

Where the precoders satisfy

$$( {N}_{t}^{TRP} \times {RI}^{CJT} ) {V}_{A} : 4 \times 2 , {V}_{B} : 4 \times 2 ,$$

and data (RI^{CJT}×1) X: 2×1. With the joint precoding, a UE would not know which data is transmitted from which TRP. The aspects of the present disclosure may be directed to frequency domain (FD) compensation reporting in CJT communication scenarios.

One area identified for potential enhancement in CJT communications is CSI acquisition. While such enhancements could benefit all implementations of CJT communications, there may be increased benefit for communication within FR1. The consideration of enhancements may assume UE communications with multiple TRP (mTRP), ideal backhaul and synchronization, as well as the same number of antenna ports across TRPs. The Type-II codebook for CJT defined in 3GPP Release 16 (Rel-16) and Release 17 (Rel-17) addresses single TRP (sTRP) communications, so one enhancement may be to refine such Rel-16/17 Type-II codebook for mTRP. The maximum number of CSI-RS ports per resource remains the same (32) as in Rel-17. In the lower-frequency bands within FR1, the size of a single TRP or antenna panel having 32 ports may be too large for practical deployment under current antenna technologies. Accordingly, a larger number of antenna port may be more readily enabled for CJT communications using distributed TRPs or antenna panels.

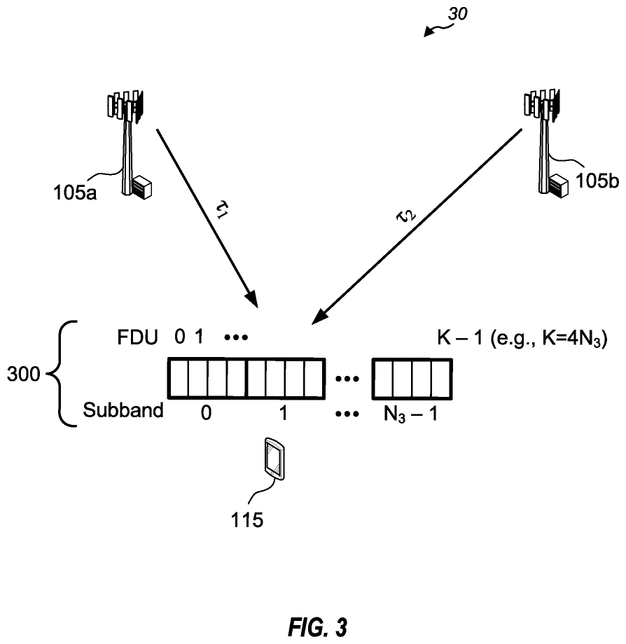

FIG. 3 is a block diagram illustrating a wireless network 30 that would support Type-II CJT CSI reporting with frequency domain compensation at a finer than subband size level according to one or more aspects. The illustrated portion of wireless network 30 includes network entities 105a and 105b that operate in a distributed, mTRP communication operation with UE 115. Because of the relation between UE 115 and each of network entities 105a and 105b, the delay, τ₂, associated with the channel between UE 115 and network entity 105b may be larger than the delay, τ₁, associated with the channel between UE 115 and network entity 105a.

Larger delay spreads in a distributed mTRP scenario may result in a more severe frequency-selectivity, even within a precoder subband. One considered solution to such increased selectivity would be to implement a finer or smaller precoding matrix indicator (PMI) subband size. However, reducing the PMI subband size may increase the UE complexity for CSI measurements, as the reduced subband size would result in a larger number of subbands. Accordingly, another solution has proposed determination of FD compensation for downlink data transmissions (e.g., PDSCH) relative to a reference TRP. For example, with network entity 105a identified as the reference TRP #1, UE 115 may determine an FD compensation for network entity 105b (as TRP #2) as an FD phase rotation according to the equation:

$$Δ ϕ = 2 π {f}_{rotate} ( {τ}_{1} - {τ}_{2} ) \qquad ( 4 )$$

The FD phase rotation of equation (4) is specifically calculated to compensate for the relative delay difference (τ₁−τ₂) using a finer granularity than a PMI subband granularity represented by the FD compensation unit, fᵣₒₜₐₜₑ.

Communication stream 300 illustrates a PMI subband size of four resource blocks (RBs). UE 115 may determine the Δϕ FD compensation based on measurement of CSI-reference signals (CSI-RS) and report such FD compensation together with the PMI in a CSI report. The reported subband-level precoder for the PMI may be given according to the equation:

$$W = [ \begin{matrix}{W}_{TRP ♯ 1} \\ {W}_{TRP ♯ 2}\end{matrix} ] \qquad ( 5 )$$

Where the precoder W_{TRP #1} for reference TRP #1 (network entity 105a) would not be FD-compensated, while the precoder W_{TRP #2} for TRP #2 (network entity 105b) is FD compensated at a reported finer frequency level or FD compensation unit (e.g., at the RB level, resource element (RE) level, or up to half of the PMI subband). Precoder W_{TRP #2} includes an FD compensation for each FD compensation unit, K. Thus, for each FD compensation unit, K, Δϕ(k), the FD compensated precoder W_{TRP #2,FDUt #k}·e^{-jkΔϕ} includes [W_{TRP #2,FDU #0}, W_{TRP #2,FDU #1}·e^{-jΔϕ}, . . . , W_{TRP #2,FDU #(K-1)}·e^{-j(K-1)Δϕ}], where K is a multiple of the total number of PMI subbands, N₃, and FDU #k represents the kth FD compensation unit (FDU) 0 to K−1.

Various aspects of the present disclosure directed to Type-II CJT CSI reporting with FD compensation at a finer than subband size level, provide solutions for the reporting of the relative delay difference τ₁−τ₂, including quantization of the FD compensation, Δϕ=2πfᵣₒₜₐₜₑ (τ₁−τ₂), determination of the reference TRP, and packing the FD compensation into uplink control information (UCI) messages. Additionally, aspects may define handling of quasi-colocation (QCL) delay for CJT-PDSCH demodulation reference signal (DMRS) where CSI-RS and tracking reference signals (TRS) are handled without FD compensation.

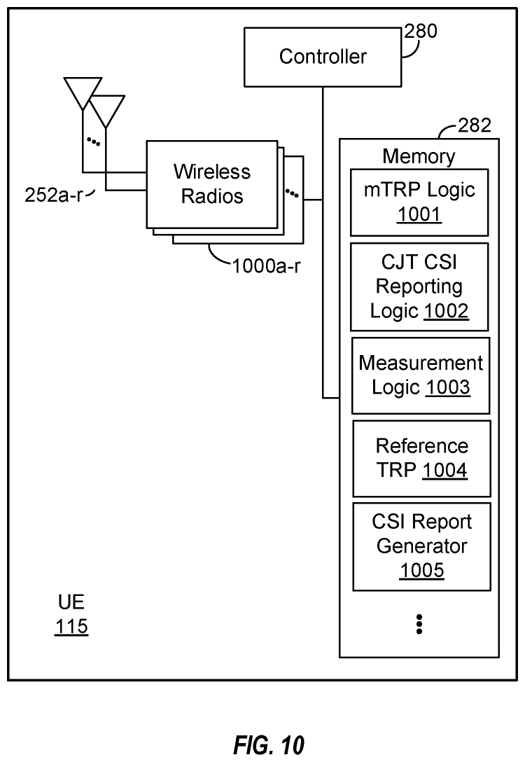

FIG. 4 is a flow diagram illustrating an example process 40 that supports Type-II CJT CSI reporting with frequency domain compensation at a finer than subband size level according to one or more aspects. Operations of process 40 may be performed by a UE, such as UE 115 described above with reference to FIGS. 1 and 2, or a UE described with reference to FIG. 10. FIG. 10 is a block diagram illustrating an example UE configured to support Type-II CJT CSI reporting with frequency domain compensation at a finer than subband size level according to one or more aspects. For example, example operations (also referred to as “blocks”) of process 40 may enable UE 115 to support Type-II CJT CSI reporting with frequency domain compensation at a finer than subband size level.

As shown, memory 282 may include mTRP logic 1001, CJT CSI reporting logic 1002, measurement logic 1003, reference TRP 1004, and CSI report generator 1005. mTRP logic 1001 includes code or instructions that, when executed under control of controller 280 (referred to herein as the “execution environment” of mTRP logic 1001), implements the capability of UE 115 to communicate with the network via multiple distributed antenna panels or TRPs. CJT CSI reporting logic 1002, when executed under control of controller 280 implements the capability for UE 115 to conduct CSI reporting for CJT with mTRP. Measurement logic 1003 includes code or instructions that, when executed under control of controller 280 implements measurement functionality within UE 115. Reference TRP 1004 provide a storage location within memory 282 for storing designation of a reference TRP among multiple TRPs operating in mTRP. CSI report generator 1005 includes code or instructions that, when executed under control of controller 280 implements the functionality of UE 115 to determine CSI parameters and assemble or pack the CSI parameters into a CSI report for transmission.

At block 400, a UE, such as UE 115, determines a plurality of CSI parameters from measurement of one or more channel conditions of CSI-RS received from a set of N_{TRP} TRPs, wherein N_{TRP} corresponds to a number of TRPs within the set of N_{TRP} TRPs. UE 115, under control of controller 280, may execute mTRP logic 1001. The execution environment of mTRP logic 1001 provides UE 115 with the functionality and capability of handling network communications through multiple, distributed antennas panels/TRPs. UE 115, under control of controller 280, may further execute CJT CSI reporting logic 1002. The execution environment of CJT CSI reporting logic 1002 enables UE 115 with the functionality and capability for determining CSI parameters for the communication channels between the multiple, distributed antenna panels/TRPs as a part of CJT communications within mTRP operations.

Within the execution environment of mTRP logic 1001 and CJT CSI reporting logic 1002, UE 115, under control of controller 280, executes measurement logic 1003. The execution environment of measurement logic 1003 enables UE 115 with the functionality and capabilities to measure reference signals (e.g., CSI-RS) from the multiple antenna panels/TRPs within the mTRP operations. The measurements resulting from such functionality and capabilities may indicate the CSI parameters that may be prepared for the CSI reporting process.

At block 401, the UE identifies a reference TRP of the set of N_{TRP} TRPs. Within the execution environment of CJT CSI reporting logic 1002, UE 115 includes capability of determining FD compensation for the non-reference TRPs. UE 115 identifies the reference TRP among the multiple, distributed TRPs, such as, for example, by determining, at UE 115, a TRP that has the highest performance characteristics, as will be discussed in greater detail below, or by signaling received from the network via one of the mTRPs. Once identified, UE 115 stores the identified reference TRP at reference TRP 1004 in memory 282.

At block 402, the UE calculates a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP. Within the execution environment of CJT CSI reporting logic 1002 and measurement logic 1003, UE 115 may calculate the FD compensation quantity for each FD compensation unit. The calculated FD compensation reflects the delay differences between each non-reference TRP and the reference TRP.

At block 403, the UE transmits a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs. Once UE 115 determines the CSI parameters including the precoders compensated with the FD compensation quantities for the mTRPs, UE 115, under control of controller 280, executes CSI report generator 1005. The execution environment of CSI report generator 1005 enables UE 115 with the functionality and capability of assembling a CSI report that includes the FD compensated precoders and other CSI parameters resulting from measurement of the reference signals. Within the execution environment of CJT CSI reporting logic 1002, UE 115 will assemble the CSI report using the CSI parameters with the FD compensated precoders associated with a total number of TRPs that are fewer than N_{TRP}−1 TRPs of the set of N_{TRP} TRPs configured for the mTRP operations.

As described with reference to FIG. 4, the present disclosure provides techniques for Type-II CJT CSI reporting with frequency domain compensation at a finer than subband size level. The various aspects of the present disclosure may extend the Type-II codebook to include CJT for multiple TRP where frequency domain (FD) compensation may be targeted for feedback. The disclosed aspects allow effective quantization of the FD compensation and define how to assemble the CSI report in order to increase the reliability of higher priority FD compensation information being transmitted.

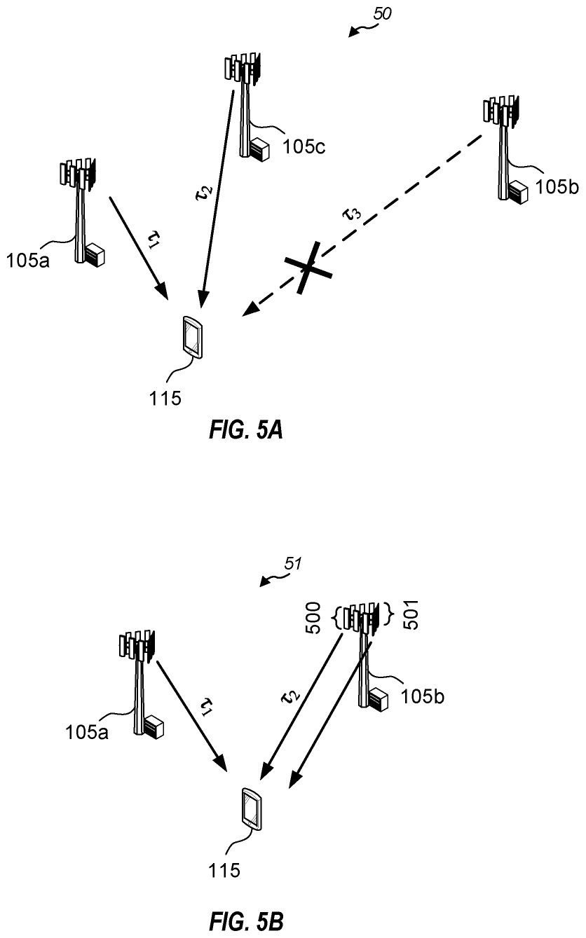

FIGS. 5A and 5B are block diagrams illustrating wireless networks 50 and 51 configured with network entities 105a-105c and UE 115 configured to support Type-II CJT CSI reporting with frequency domain compensation at a finer than subband size level according to one or more aspects. For a UE, such as UE 115 illustrated in FIGS. 5A and 5B, configured with CJT mTRP CSI reporting the relative delay differences for N_{TRP} TRPs, UE 115 can transmit a CSI report with the FD compensation for a variable number, M, of TRPs. Various aspects of the present disclosure may include UE 115 configured with different total numbers of TRPs, where N_{TRP} may be 2, 3, 4, etc. UE 115 may then transmit a CSI report with PMI parameters and FD compensation for the variable M TRPs, where MS N_{TRP}−1. In the case of M=N_{TRP}−1, UE 115 includes FD compensation in the PMI parameters related to all TRPs other than the reference TRP.

The aspects of the present disclosure are directed to the case in which UE 115 transmits a CSI report with PMI parameters and FD compensation for the variable M TRPs, where M<N_{TRP}−1. UE 115 may select the reduced number of TRPs base on different capabilities or operations. In a first example aspect, as illustrated in FIG. 5A, UE 115 has a capability to perform TRP selection. With such capability, UE 115 identifies the delays related to each of network entities 105a-105c. UE 115 identifies the delay in the channel with network entity 105a is τ₁, the delay in the channel with network entity 105c is τ₃, and the delay in the channel with network entity 105b is τ₂. UE 115 may determine that the delay 12 may complicate the mTRP communications considering delays τ₁ and τ₃ are different but not as long as delay τ₂. In such determination, UE 115 may then elect to ignore network entity 105b, having delay τ₂, and selects CSI reporting with PMI parameters and FD compensation for M=1 (for network entity 105c) TRPs, with network entity 105a being identified as the reference TRP. Thus, (M=1)<(N_{TRP}−1), where N_{TRP}=3.

In a second example aspect, as illustrated in FIG. 5B, UE 115 has a capability to group TRPs that may have the same delay. For example, network entity 105b includes two antenna panels 500 and 501 within the mTRP communications with UE 115. Antenna panel 500 may be oriented in a different spatial direction than antenna panel 501 and, thus, may be considered separate TRPs for the mTRP communication. In such illustrated example, N_{TRP}=3, including network entity 105a and antenna panels 500 and 501 of network entity 105b. UE 115 identifies the delay in the channel with network entity 105a is τ₁, the delay in the channel with antenna panel 500 of network entity 105b is τ₂, and the delay in the channel with antenna panel 501 of network entity 105b is also τ₂. Because the delay, τ₂, for antenna panels 500 and 501, UE 115 may group the FD compensation and PMI parameters related to antenna panels 500 and 501 into a single TRP. Therefore, UE 115 selects CSI reporting with PMI parameters and FD compensation for M=1 (for antenna panels 500 and 501 of network entity 105b) TRPs, with network entity 105a being identified as the reference TRP.

The various aspects of the present disclosure provide for an identification of a reference TRP among the N_{TRP} TRPs in communication with UE 115. The identification of the reference TRP may be function of a configuration from a network entity (e.g., network entities 105a-105c) or may be selected by UE 115 based on a measure of performance characteristics of each TRP. In a first optional implementation, a network entity, such as network entities 105a-105c, may transmit a configuration message (e.g., master information block (MIB), system information block (SIB), radio resource control (RRC) message, medium access control-control element (MAC-CE), etc.) that includes configuration of the reference TRP. UE 115 would then identify the reference TRP in response to this configuration message.

In a second example implementation, UE 115 may select the reference TRP based on the performance characteristics of the TRP (e.g., network entities 105a-105c and antennas panels 500-501). Performance characteristics may include measured aspects such as a the strength or highest total power. Strength may be determined according to the strongest coefficient indicator (SCI) associated with a particular TRP, while power may be determined according to the \tilde{W}₂ coefficients related with this TRP. UE 115 may select the TRP having the highest performance characteristics, such as the TRP associated with the SCI or the TRP having the highest total power based on its \tilde{W}₂ coefficients.

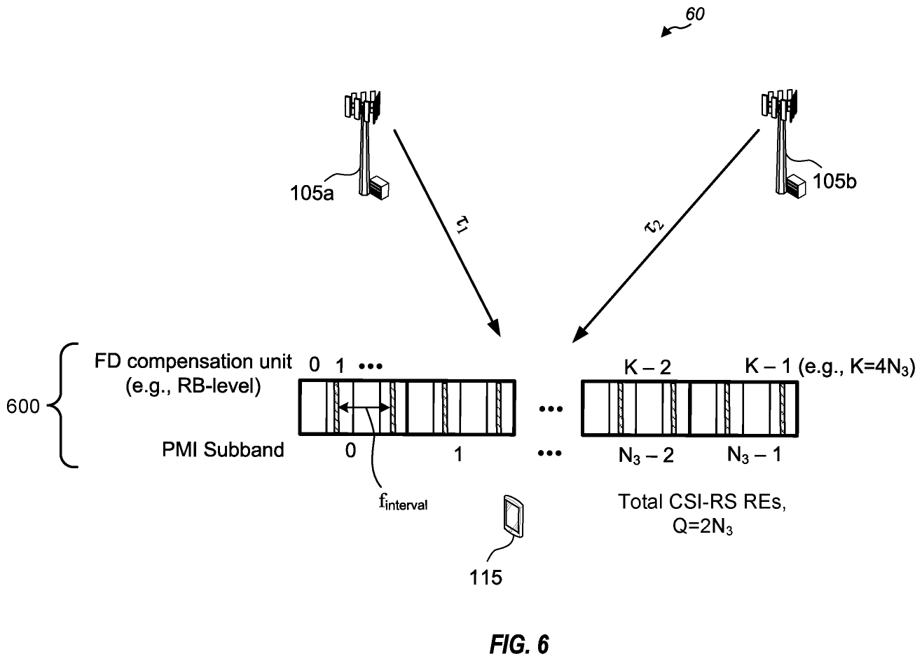

FIG. 6 is a block diagram illustrating a wireless network 60 configured with network entities 105a-105b and UE 115 configured to support Type-II CJT CSI reporting with frequency domain compensation at a finer than subband size level according to one or more aspects. The illustrated portion of wireless network 60 includes network entities 105a and 105b that operate in a distributed, mTRP communication operation with UE 115. Because of the relation between UE 115 and each of network entities 105a and 105b, the delay, τ₂, associated with the channel between UE 115 and network entity 105b may be larger than the delay, τ₁, associated with the channel between UE 115 and network entity 105a. Communication stream 600 illustrates an example PMI subband size of four resource blocks (RBs) per subband. UE 115 may determine the Δϕ FD compensation based on measurement of CSI-RS and report such FD compensation together with the PMI in a CSI report. Communication stream 600 further illustrates an example CSI-RS FD density of 0.5 resource elements (REs) per RB, where fᵢₙₜₑᵣᵥₐₗ represents the FD compensation over the CSI-RS FD density or RE interval, with the example implementation illustrated in FIG. 6 reflecting, fᵢₙₜₑᵣᵥₐₗ=2RB.

It should be noted that the example values for PMI subband size and CSI-RS FD density are simply examples. The present aspects are not limited to the example sizes. PMI subband size may typically be at least 2 RBs per subband, while CSI-RS FD density may different values of RE per RB.

As noted in Equation (4), Δϕ=2πfᵣₒₜₐₜₑ (τ₁−τ₂), fᵣₒₜₐₜₑ denotes the FD compensation unit that is determined over a finer or smaller than the legacy PMI subband scale. The resolution of delay difference τ₁−τ₂ may be determined through an inverse proportionality with the total bandwidth,

$$\frac{1}{BW} = \frac{1}{{N}_{3} {f}_{sb}} .$$

The maximum measurable delay may be determined through an inverse proportionality with the CSI-RS FD density or RE interval,

$$\frac{1}{{f}_{interval}} .$$

For example, a certain delay difference, τ₁−τ₂, may be measured or determined as

$$\frac{q}{{N}_{3} {f}_{s b}} ,$$

q=0, 1, . . . , Q−1, where

$$Q = \frac{{N}_{3} {f}_{s b}}{{f}_{interval}}$$

represents a total number of REs for each one of the CSI-RS, where f_{sb} denotes the FD compensation calculated on the legacy PMI subband scale. The example implementation illustrated in FIG. 6 reflects, Q=2N₃; however other example implementations may include different values of Q. Therefore, quantization resolution of Δϕ may be determined according to

$$\frac{2 π {f}_{rotate}}{BW} = \frac{2 π}{K} .$$

where K represents a total number of FD compensation units. For example, a certain Δϕ compensation is reported as

$$\frac{2 π q}{K} ,$$

q=0, 1, . . . , Q−1, where

$$Q = \frac{{N}_{3} {f}_{s b}}{{f}_{interval}} .$$

According to the example implementation illustrated in FIG. 6, the maximum Δϕ compensation reported may be expressed as

$${Δϕ}_{ma x} = Δ ϕ ( Q - 1 ) = \frac{2 π ( 2 {N}_{3} - 1 )}{4 {N}_{3}} ,$$

which would be nearly one-half of 2π. Typically, a phase value, including phase compensation values, may generally range between 0 and 2π.

It should be noted that in additional or alternative aspects, the FD interval size of CSI-RS RE, fᵢₙₜₑᵣᵥₐₗ, and FD compensation unit size, fᵣₒₜₐₜₑ, can be the same, fᵢₙₜₑᵣᵥₐₗ=fᵣₒₜₐₜₑ, which would corresponds to a special case where the total number of REs for each one of the CSI-RS, Q, would equal the total number of FD compensation units, K:Q=K.

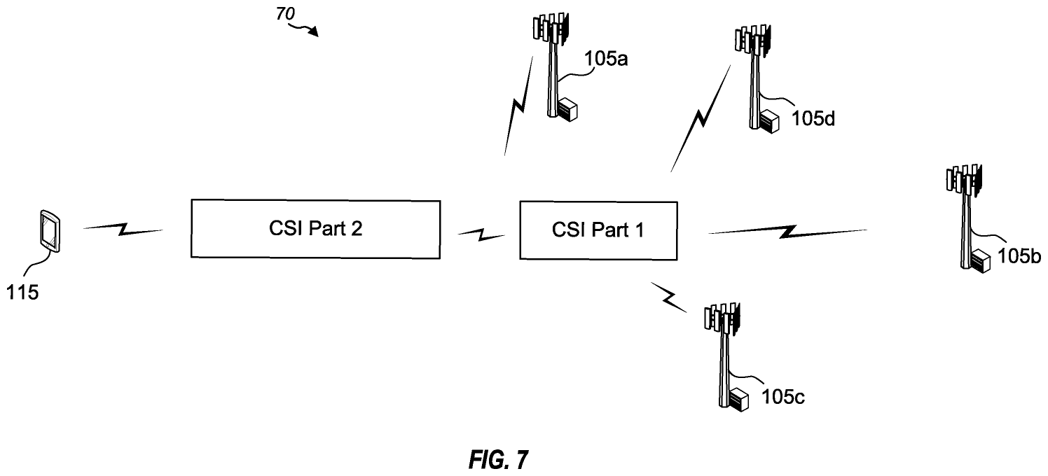

FIG. 7 is a block diagrams illustrating wireless network 70 configured with network entities 105a-105d and UE 115 configured to support Type-II CJT CSI reporting with frequency domain compensation at a finer than subband size level according to one or more aspects. UE 115 is in communication with N_{TRP}=4 TRPs (network entities 105a-105d). Upon identification of the reference TRP and determining the M TRPs of the N_{TRP} TRPs in communication with UE 115, UE 115 may transmit a CSI report including the PMI parameters and FD compensation for the non-reference TRPs. Due to its large payload size, a CSI report may be divided into two parts, CSI part 1 and CSI part 2, for transmission. CSI part 1 may be considered more significant and is configured with a smaller, typically fixed, payload size, and transmitted with higher reliability. CSI part 1 may include the rank indicator, channel quality indicator (CQI), and number of non-zero coefficients (NZCs).

CSI part 2 may have a larger, dynamic payload side. A network entity may determine the size of CSI part 2 based on the decoded CSI part 1. For example, the network entity, such as network entities 105a-105d, may use the rank indicator (RI) and number of NZCs to determine the payload size of CSI part 2. CSI part 2 may include the spatial domain basis selection, the frequency domain selection for layers 0−(RI−1), the SCI for layers 0−(RI−1), the coefficient selection for layers 0−(RI−1), and the quantization of NZCs for layers 0−(RI−1).

When generating the CSI report, UE 115 would quantize the FD compensation quantities of the non-reference TRPs in order to assemble (referred to herein as “pack,” “packed,” “packing”) the information into the CSI part 1 or CSI part 2. To determine the quantization bit, the FD compensation unit, which, according to the aspects of the present disclosure, is calculated based on a unit size finer or smaller than the PMI subband size, may be denoted, as noted above, as fᵣₒₜₐₜₑ. The FD compensation calculated on a PMI subband size may be denoted as f_{sb}. The FD compensation calculated on a PMI subband size may be an integer multiple of the FD interval of CSI-RS RE, such that f_{sb}=Zfᵢₙₜₑᵣᵥₐₗ, where Z is an integer. As noted above, the total number of FD compensation units at the finer unit size may be the same integer, Z, multiple of the total number of PMI subbands, N₃, such that Q=Z·N₃. The quantization of the FD compensation, representative of the relative delay difference (e.g., Δϕ=2πfᵣₒₜₐₜₑ (τ₁−τ₂)), may be based on Q.

In a first optional aspect, UE 115 may quantize the FD compensation for all M TRPs each with log₂ Q bits. For example, for the M<N_{TRP}−1 reported FD compensations reflecting the relative delay difference, τ_{ref}−τₘ, m=1, . . . , M−1, UE 115 may quantize each FD compensations, representing Δϕₘ=2πqₘ/K, qₘ=0, 1, . . . , Q−1, using the log₂ Q bits for each of the M TRPs. With regard to the first optional aspect, UE 115 may pack the quantized FD compensations into CSI part 2 for transmission.

In a second optional aspect, UE 115 may divide the reporting of the FD compensations, in which one part of the FD compensations may be packed into CSI part 1 and the other part packed into CSI part 2. For example, UE 115 may quantize and report the FD compensation for a first designated TRP (Δϕ₁ (q₁)) of the M reported TRPs. UE 115 may quantize the FD compensation for a first designated TRP (Δϕ₁ (q₁)) using log₂ Q bits and pack these parameters into CSI part 1. UE 115 may quantize the FD compensation for the remaining M−1 TRPs Δϕₘ (qₘ) (m=2, . . . , M, if M>1) using a second number of bits and pack these parameters into CSI part 2. The second number of bits may be dependent on the characterization of the first designated TRP.

In a first example implementation, the first designated TRP may represent the reported TRP having the minimum delay relative to the reference TRP. In such example implementation, UE 115 may use log₂ (Q−q₁) bits to quantize the FD compensation for each of the remaining M−1 TRPs Δϕₘ(qₘ) (m=2, . . . , M, if M>1).

In a second example implementation, the first designated TRP may represent the report TRP having the maximum delay relative to the reference TRP. In such example implementation, UE 115 may use log₂ Q bits to quantize the FD compensation for each of the remaining M−1 TRPs Δϕₘ(qₘ) (m=2, . . . , M, if M>1). Thus, the number of quantization bits for the remaining M−1 TRPs may be selected depending on whether the first designated TRP is associated with the minimum or maximum delay, respectively.

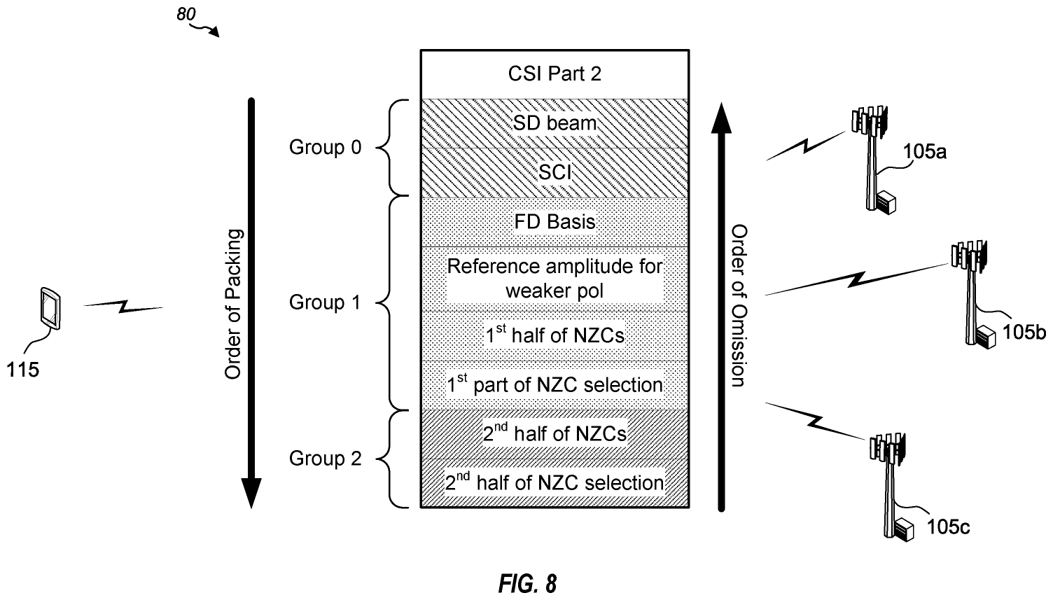

FIG. 8 is a block diagrams illustrating wireless network 80 configured with network entities 105a-105c and UE 115 configured to support Type-II CJT CSI reporting with frequency domain compensation at a finer than subband size level according to one or more aspects. As noted above, CSI part 2 has a variable payload size. Additionally, depending on available resources, a UE, such as UE 115, may elect to omit some parts of the payload. Different portions of CSI part 2 have a priority level when determining which parts to omit from the report. UE 115 also uses a specific packing order when assembling CSI part 2. As illustrated, UE 115 may pack identification of the spatial domain beam and SCI into Group 0, which is packed first into CSI part 2 and has the highest priority when determining omitted portions. The next portion of CSI part 2, Group 1, is packed by UE 115 with the FD basis, reference amplitude for the weaker polarization, first half of NZCs, and first part of the NZC selection. Group 1 also has the next highest priority when determining portions to omit from CSI part 2. The final portion of CSI part 2, Group 2, is packed by UE 115 with the second half of NZCs and the second half of NZC selection. Group 2 has the lowest priority when determining portions to omit from CSI part 2.

With reference to the second optional aspect illustrated in FIG. 7, the packing of the quantized FD compensation for the remaining M−1 TRPs Δϕₘ (kₘ, m=2, . . . , M, if M>1) into CSI part 2 may occur into either Group 0 or Group 1. Similarly, with reference to the second example implementation of the second optional aspect, an additional indication of the TRP index associated with the first designated TRP, whether representative of the minimum or maximum delay, may also be packed in Group 0 or Group 1 of CSI part 2.

It should be noted that the DMRS ports of CJT PDSCH are considered QCL to all transmission configuration indication (TCI) states associated with all related TRPs. With this relationship, for the CJT PDSCH with FD compensation with M TRPs (M<N_{TRP}−1) according to the various aspects of the present disclosure, the delay QCL parameters (e.g., average delay, and/or, delay spread) for CSI-RS(s)/TRS(s) from these TRP m=1, . . . , M would be valid as to the reference TRP, but invalid for each non-reference TRP. UE 115 should then obtain an indication that would allow UE 115 to identify the TCI(s) or the TRP(s) associated with the invalid delay QCL parameters. In a first optional aspect, A PDSCH may be scheduled having a single TCI associated with the reference TRP. Because there is the single TCI pointing to the reference TRP, UE 115 would be capable of determining that the delay QCL parameters are applicable to the reference TRP and not the non-reference TRPs.

In a second optional aspect, UE 115 may receive a configuration message (e.g., RRC configuration, downlink control information (DCI) indication, etc.) that includes an indication that informs UE 115 that, while the PDSCH transmission is scheduled with multi-TCI and has delay QCL (average delay, and/or, delay spread), UE 115 knows that the delay QCL is invalid with respect to the non-reference TRPs. In a first optional implementation, additional bits for the configuration message may be defined to indicate the TCI state having valid delay QCL (the reference TRP), e.g., 1-bit for 2-TCI, 2-bit for 3-/4-TCI, etc. In a second option implementation, UE 115 may presume that the first TCI state of the PDSCH configuration is associated with the reference TRP. In such implementation, no additional indication or bits would be used to identify the TCI associated with the reference TRP.

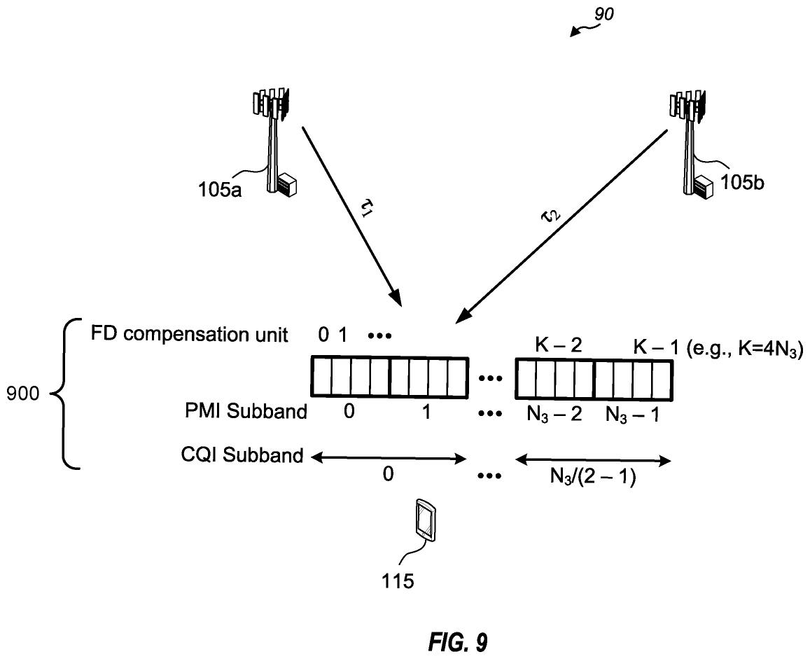

FIG. 9 is a block diagram illustrating a wireless network 90 configured with network entities 105a-105b and UE 115 configured to support Type-II CJT CSI reporting with frequency domain compensation at a finer than subband size level according to one or more aspects. The illustrated portion of wireless network 90 includes network entities 105a and 105b that operate in a distributed, mTRP communication operation with UE 115. Because of the relation between UE 115 and each of network entities 105a and 105b, the delay, τ₂, associated with the channel between UE 115 and network entity 105b may be larger than the delay, τ₁, associated with the channel between UE 115 and network entity 105a. Communication stream 900 illustrates a PMI subband size of four resource blocks (RBs). UE 115 may determine the Δϕ FD compensation based on measurement of CSI-reference signals (CSI-RS) and report such FD compensation together with the PMI in a CSI report.

The aspects according to the present disclosure may determine the Δϕ FD compensation using an FD compensation unit finer or smaller than the PMI subband size. The wideband or subband CQI reported by UE 115 may be based on the FD compensated precoder (PMI) report using the finer granularity unit size than the PMI subband size. The CQI subband size may further be larger than the PMI subband size. As illustrated and by example only, one CQI subband is equivalent to two PMI subbands. However, the wideband and subband CQI reported may be based on the FD compensated precoder (PMI) report using the finer granularity unit size than the PMI subband size. For example, UE 115 may determine the CQI based on the reported precoder:

$$W = [ \begin{matrix}{W}_{TRP ♯ 1} \\ {W}_{TRP ♯ 2}\end{matrix} ] \qquad ( 6 )$$

Before FD compensation, where TRP #1 represents the reference TRP, and the FD compensated TRP #2 precoder includes [W_{TRP #2,unit #0}, W_{TRP #2,unit #1}·e^{-jΔϕ}, . . . , W_{TRP #2,unit #(K-1)}·e^{-j(K-1)Δϕ}].

It is noted that one or more blocks (or operations) described with reference to FIG. 4 may be combined with one or more blocks (or operations) described with reference to another of the figures. For example, one or more blocks (or operations) of FIG. 4 may be combined with one or more blocks (or operations) of FIGS. 5A and 5B. As another example, one or more blocks associated with FIG. 4 may be combined with one or more blocks associated with FIG. 6. As another example, one or more blocks associated with FIG. 7 may be combined with one or more blocks (or operations) associated with FIGS. 1-2. Additionally, or alternatively, one or more operations described above with reference to FIGS. 1-2 may be combined with one or more operations described with reference to FIG. 10.

In one or more aspects, techniques for supporting Type-II CJT CSI reporting with frequency domain compensation at a finer than subband size level may include additional aspects, such as any single aspect or any combination of aspects described below or in connection with one or more other processes or devices described elsewhere herein. In one or more aspects, supporting Type-II CJT CSI reporting with frequency domain compensation at a finer than subband size level may include an apparatus configured to determine a plurality of CSI parameters from measurement of one or more channel conditions of CSI-RS received from a set of N_{TRP} TRPs, wherein N_{TRP} corresponds to a number of TRPs within the set of N_{TRP} TRPs, identify a reference TRP of the set of N_{TRP} TRPs, calculate a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP, and transmit a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus. In some implementations, the apparatus may include a chip set made up of a collection of processors and integrated circuit chips that may be grouped together as the chip set deployed in a wireless device, including a UE, a receiver, a transmitter, or the like, configured to execute instructions and control components to perform the operations described herein.

A first aspect may include a UE configured with CJT mTRP CSI reporting, the UE comprising: a memory storing processor-readable code; and at least one processor coupled to the memory. The processor-readable code executable by the at least one processor to cause the UE to determine a plurality of CSI parameters from measurement of one or more channel conditions of CSI-RS received from a set of N_{TRP} TRPs, wherein N_{TRP} corresponds to a number of TRPs within the set of N_{TRP} TRPs; identify a reference TRP of the set of N_{TRP} TRPs; calculate a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP; and transmit a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

In a second aspect, alone or in combination with the first aspect, including the processor-readable code executable by the at least one processor to further cause the UE to one of: select the fewer than N_{TRP}−1 TRPs as the one or more reported TRPs and exclude non-selected TRPs of the set of N_{TRP} TRPs; or identify one precoder applicable to one reported TRP of the one or more reported TRPs as representative of a group of two or more TRPs of the set of N_{TRP} TRPs having a same delay difference between each of the group of two or more TRPs and the reference TRP.

In a third aspect, alone or in combination with one or more of the first aspect or the second aspect, wherein the processor-readable code executable by the at least one processor to cause the UE to identify the reference TRP includes processor-readable code executable by the at least one processor to cause the UE to one of: receive a configuration message from a serving network entity, wherein the configuration message identifies the reference TRP; or select the reference TRP having a highest performance characteristic as determined by the UE among the set of N_{TRP} TRPs.

In a fourth aspect, alone or in combination with one or more of the first aspect through the third aspect, including the processor-readable code executable by the at least one processor to further cause the UE to: generate the CSI report including the CSI parameters with the precoder and the frequency domain compensation quantity for each frequency compensation unit, wherein the CSI report includes a CSI part 1 having a fixed payload size and a CSI part 2 have a variable payload size; quantize the frequency domain compensation quantity for each frequency compensation unit with log₂ Q bits into a quantized frequency domain compensation, wherein Q represents a total number of resource elements (REs) for each one of the CSI-RS; and packing the quantized frequency domain compensation into the CSI part 2.

In a fifth aspect, alone or in combination with one or more of the first aspect through the fourth aspect, wherein the CSI part 2 is packed according to a hierarchical plurality of bit groups, wherein the hierarchical plurality of bit groups include: a first bit group packed into the CSI part 2 first, a second bit group packed into the CSI part 2 second, and a third bit group packed into the CSI part 2 last, and wherein the log₂ Q bits of the quantized frequency domain compensation are packed into one of the first bit group or the second bit group.

In a sixth aspect, alone or in combination with one or more of the first aspect through the fifth aspect, including the processor-readable code executable by the at least one processor to further cause the UE to: generate the CSI report including the CSI parameters with the precoder and the frequency domain compensation quantity for each frequency compensation unit, wherein the CSI report includes a CSI part 1 having a fixed payload size and a CSI part 2 have a variable payload size; quantize a first designated frequency domain compensation quantity of the frequency domain compensation quantity for each frequency compensation unit associated with a first designated precoder applicable to a first designated TRP of the one or more reported TRPs, wherein the first designated frequency domain compensation quantity is quantized with log₂ Q bits into a quantized first designated frequency domain compensation, wherein (represents a total number of REs for each one of the CSI-RS; quantize one or more remaining frequency domain compensation quantities of the frequency domain compensation quantity for each frequency compensation unit with a second number of bits into a quantized remaining frequency domain compensation; and packing the quantized first designated frequency domain compensation into the CSI part 1 and the quantized remaining frequency domain compensation into the CSI part 2.

In a seventh aspect, alone or in combination with one or more of the first aspect through the sixth aspect, wherein the first designated frequency domain compensation quantity represents one of a minimum delay or maximum delay of the first designated TRP relative to the reference TRP, and wherein the second number of bits includes one of: log₂ (Q−q₁) bits when the designated frequency domain compensation quantity represents the minimum delay, wherein q₁ represents the frequency domain compensation quantity for the each frequency compensation unit corresponding to the first designated TRP, or log₂ q₁ bits when the designated frequency domain compensation quantity represents the maximum delay.

In an eighth aspect, alone or in combination with one or more of the first aspect through the seventh aspect, including the processor-readable code executable by the at least one processor to further cause the UE to: identify a TRP index of the first designated TRP; and pack the TRP index into the CSI part 2, wherein the CSI part 2 is packed according to a hierarchical plurality of bit groups, wherein the hierarchical plurality of bit groups include: a first bit group packed into the CSI part 2 first, a second bit group packed into the CSI part 2 second, and a third bit group packed into the CSI part 2, and wherein the TRP index and the second number of bits of the quantized remaining frequency domain compensation are packed into one of the first bit group or the second bit group.

In a ninth aspect, alone or in combination with one or more of the first aspect through the eighth aspect, including the processor-readable code executable by the at least one processor to further cause the UE to: obtain an identification of the reference TRP; receive a PDSCH scheduled with a plurality of TCI states and having one or more QCL parameters including an average delay or a delay spread; identify the average delay or the delay spread applicable to the reference TRP; and invalidate the average delay or the delay spread as to the each non-reference TRP.

In a tenth aspect, alone or in combination with one or more of the first aspect through the ninth aspect, wherein the processor-readable code executable by the at least one processor to cause the UE to obtain the identification includes processor-readable code executable by the at least one processor to cause the UE to identify an identified TRP of the set of N_{TRP} TRPs as the reference TRP, wherein the identified TRP is identified by a first TCI state of the plurality of TCI states.

In an eleventh aspect, alone or in combination with one or more of the first aspect through the tenth aspect, wherein the processor-readable code executable by the at least one processor to cause the UE to obtain the identification includes processor-readable code executable by the at least one processor to cause the UE to: receive a downlink control message including an identifier of a TCI state of the plurality of TCI states associated with the reference TRP.

In a twelfth aspect, alone or in combination with one or more of the first aspect through the eleventh aspect, wherein a size of the frequency domain compensation unit is less than a PMI subband by an integer multiple.

In a thirteenth aspect, alone or in combination with one or more of the first aspect through the twelfth aspect, wherein the processor-readable code executable by the at least one processor to cause the UE to determine a plurality of CSI parameters includes the processor-readable code executable by the at least one processor to cause the UE to: determine wideband CQI and subband CQI based on the precoder for the one or more reported TRPs compensated by the frequency domain compensation quantity for each frequency compensation unit.

A fourteenth aspect includes a method of wireless communication performed by a UE, including determining a plurality of CSI parameters from measurement of one or more channel conditions of CSI-RS received from a set of N_{TRP} TRPs, wherein N_{TRP} corresponds to a number of TRPs within the set of N_{TRP} TRPs; identifying a reference TRP of the set of N_{TRP} TRPs; calculating a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP; and transmitting a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

In a fifteenth aspect, alone or in combination with the fourteenth aspect, further including one of: selecting the fewer than N_{TRP}−1 TRPs as the one or more reported TRPs and exclude non-selected TRPs of the set of N_{TRP} TRPs; or identifying one precoder applicable to one reported TRP of the one or more reported TRPs as representative of a group of two or more TRPs of the set of N_{TRP} TRPs having a same delay difference between each of the group of two or more TRPs and the reference TRP.

In a sixteenth aspect, alone or in combination with one or more of the fifteenth aspect or the fourteenth aspect, wherein the identifying the reference TRP includes one of: receiving a configuration message from a serving network entity, wherein the configuration message identifies the reference TRP; or selecting the reference TRP having a highest performance characteristic as determined by the UE among the set of N_{TRP} TRPs.

In a seventeenth aspect, alone or in combination with one or more of the fourteenth amendment through the sixteenth amendment, further including: generating the CSI report including the CSI parameters with the precoder and the frequency domain compensation quantity for each frequency compensation unit, wherein the CSI report includes a CSI part 1 having a fixed payload size and a CSI part 2 have a variable payload size; quantizing the frequency domain compensation quantity for each frequency compensation unit with log₂ Q bits into a quantized frequency domain compensation, wherein Q represents a total number of REs for each one of the CSI-RS; and packing the quantized frequency domain compensation into the CSI part 2.

In an eighteenth aspect, alone or in combination with one or more of the fourteenth amendment through the seventeenth aspect, wherein the CSI part 2 is packed according to a hierarchical plurality of bit groups, wherein the hierarchical plurality of bit groups include: a first bit group packed into the CSI part 2 first, a second bit group packed into the CSI part 2 second, and a third bit group packed into the CSI part 2 last, and wherein the log₂ Q bits of the quantized frequency domain compensation are packed into one of the first bit group or the second bit group.

In a nineteenth aspect, alone or in combination with one or more of the fourteenth amendment through the eighteenth aspect, further including: generating the CSI report including the CSI parameters with the precoder and the frequency domain compensation quantity for each frequency compensation unit, wherein the CSI report includes a CSI part 1 having a fixed payload size and a CSI part 2 have a variable payload size; quantizing a first designated frequency domain compensation quantity of the frequency domain compensation quantity for each frequency compensation unit associated with a first designated precoder applicable to a first designated TRP of the one or more reported TRPs, wherein the first designated frequency domain compensation quantity is quantized with log₂ Q bits into a quantized first designated frequency domain compensation, wherein Q represents a total number of REs for each one of the CSI-RS; quantizing one or more remaining frequency domain compensation quantities of the frequency domain compensation quantity for each frequency compensation unit with a second number of bits into a quantized remaining frequency domain compensation; and packing the quantized first designated frequency domain compensation into the CSI part 1 and the quantized remaining frequency domain compensation into the CSI part 2.

In a twentieth aspect, alone or in combination with one or more of the fourteenth amendment through the nineteenth aspect, wherein the first designated frequency domain compensation quantity represents one of a minimum delay or maximum delay of the first designated TRP relative to the reference TRP, and wherein the second number of bits includes one of: log₂ (Q−q₁) bits when the designated frequency domain compensation quantity represents the minimum delay, wherein q₁ represents the frequency domain compensation quantity for the each frequency compensation unit corresponding to the first designated TRP, or log₂ q₁ bits when the designated frequency domain compensation quantity represents the maximum delay.

In a twenty-first aspect, alone or in combination with one or more of the fourteenth amendment through the twentieth aspect, further including: identifying a TRP index of the first designated TRP; and packing the TRP index into the CSI part 2, wherein the CSI part 2 is packed according to a hierarchical plurality of bit groups, wherein the hierarchical plurality of bit groups include: a first bit group packed into the CSI part 2 first, a second bit group packed into the CSI part 2 second, and a third bit group packed into the CSI part 2, and wherein the TRP index and the second number of bits of the quantized remaining frequency domain compensation are packed into one of the first bit group or the second bit group.

In a twenty-second aspect, alone or in combination with one or more of the fourteenth amendment through the twenty-first aspect, further including: obtaining an identification of the reference TRP; receiving a PDSCH scheduled with a plurality of TCI states and having one or more QCL parameters including an average delay or a delay spread; identifying the average delay or the delay spread applicable to the reference TRP; and invalidating the average delay or the delay spread as to the each non-reference TRP.

In a twenty-third aspect, alone or in combination with one or more of the fourteenth amendment through the twenty-second aspect, wherein the obtaining the identification includes identifying an identified TRP of the set of N_{TRP} TRPs as the reference TRP, wherein the identified TRP is identified by a first TCI state of the plurality of TCI states.

In a twenty-fourth aspect, alone or in combination with one or more of the fourteenth amendment through the twenty-third aspect, wherein the obtaining the identification includes receiving a downlink control message including an identifier of a TCI state of the plurality of TCI states associated with the reference TRP.

In a twenty-fifth aspect, alone or in combination with one or more of the fourteenth amendment through the twenty-fourth aspect, wherein a size of the frequency domain compensation unit is less than a PMI subband by an integer multiple.

In a twenty-sixth aspect, alone or in combination with one or more of the fourteenth amendment through the twenty-fifth aspect, wherein the determining a plurality of CSI parameters includes determining wideband CQI and subband CQI based on the precoder for the one or more reported TRPs compensated by the frequency domain compensation quantity for each frequency compensation unit.

A twenty-seventh aspect may include a UE configured with CJT mTRP CSI reporting, comprising: means for determining a plurality of CSI parameters from measurement of one or more channel conditions of CSI-RS received from a set of N_{TRP} TRPs, wherein N_{TRP} corresponds to a number of TRPs within the set of N_{TRP} TRPs; means for identifying a reference TRP of the set of N_{TRP} TRPs; means for calculating a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP; and means for transmitting a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

In a twenty-eighth aspect, alone or in combination with the twenty-seventh aspect, further including one of: means for selecting the fewer than N_{TRP}−1 TRPs as the one or more reported TRPs and exclude non-selected TRPs of the set of N_{TRP} TRPs; or means for identifying one precoder applicable to one reported TRP of the one or more reported TRPs as representative of a group of two or more TRPs of the set of N_{TRP} TRPs having a same delay difference between each of the group of two or more TRPs and the reference TRP.

In a twenty-ninth aspect, alone or in combination with one or more of the twenty-seventh aspect or the twenty-eighth aspect, wherein the means for identifying the reference TRP includes one of: means for receiving a configuration message from a serving network entity, wherein the configuration message identifies the reference TRP; or means for selecting the reference TRP having a highest performance characteristic as determined by the UE among the set of N_{TRP} TRPs.

In a thirtieth aspect, alone or in combination with one or more of the twenty-seventh aspect through the twenty-ninth aspect, further including: means for generating the CSI report including the CSI parameters with the precoder and the frequency domain compensation quantity for each frequency compensation unit, wherein the CSI report includes a CSI part 1 having a fixed payload size and a CSI part 2 have a variable payload size; means for quantizing the frequency domain compensation quantity for each frequency compensation unit with log₂ Q bits into a quantized frequency domain compensation, wherein Q represents a total number of resource elements (REs) for each one of the CSI-RS; and means for packing the quantized frequency domain compensation into the CSI part 2.

In a thirty-first aspect, alone or in combination with one or more of the twenty-seventh aspect through the thirtieth aspect, wherein the CSI part 2 is packed according to a hierarchical plurality of bit groups, wherein the hierarchical plurality of bit groups include: a first bit group packed into the CSI part 2 first, a second bit group packed into the CSI part 2 second, and a third bit group packed into the CSI part 2 last, and wherein the log₂ Q bits of the quantized frequency domain compensation are packed into one of the first bit group or the second bit group.

In a thirty-second aspect, alone or in combination with one or more of the twenty-seventh aspect through the thirty-first aspect, further including: means for generating the CSI report including the CSI parameters with the precoder and the frequency domain compensation quantity for each frequency compensation unit, wherein the CSI report includes a CSI part 1 having a fixed payload size and a CSI part 2 have a variable payload size; means for quantizing a first designated frequency domain compensation quantity of the frequency domain compensation quantity for each frequency compensation unit associated with a first designated precoder applicable to a first designated TRP of the one or more reported TRPs, wherein the first designated frequency domain compensation quantity is quantized with log 2 (bits into a quantized first designated frequency domain compensation, wherein (represents a total number of REs for each one of the CSI-RS; means for quantizing one or more remaining frequency domain compensation quantities of the frequency domain compensation quantity for each frequency compensation unit with a second number of bits into a quantized remaining frequency domain compensation; and means for packing the quantized first designated frequency domain compensation into the CSI part 1 and the quantized remaining frequency domain compensation into the CSI part 2.

In a thirty-third aspect, alone or in combination with one or more of the twenty-seventh aspect through the thirty-second aspect, wherein the first designated frequency domain compensation quantity represents one of a minimum delay or maximum delay of the first designated TRP relative to the reference TRP, and wherein the second number of bits includes one of: log₂ (Q−q₁) bits when the designated frequency domain compensation quantity represents the minimum delay, wherein q₁ represents the frequency domain compensation quantity for the each frequency compensation unit corresponding to the first designated TRP, or log₂ q₁ bits when the designated frequency domain compensation quantity represents the maximum delay.

In a thirty-fourth aspect, alone or in combination with one or more of the twenty-seventh aspect through the thirty-third aspect, further including: means for identifying a TRP index of the first designated TRP; and means for packing the TRP index into the CSI part 2, wherein the CSI part 2 is packed according to a hierarchical plurality of bit groups, wherein the hierarchical plurality of bit groups include: a first bit group packed into the CSI part 2 first, a second bit group packed into the CSI part 2 second, and a third bit group packed into the CSI part 2, and wherein the TRP index and the second number of bits of the quantized remaining frequency domain compensation are packed into one of the first bit group or the second bit group.

In a thirty-fifth aspect, alone or in combination with one or more of the twenty-seventh aspect through the thirty-fourth aspect, further including: means for obtaining an identification of the reference TRP; means for receiving a PDSCH scheduled with a plurality of TCI states and having one or more QCL parameters including an average delay or a delay spread; means for identifying the average delay or the delay spread applicable to the reference TRP; and means for invalidating the average delay or the delay spread as to the each non-reference TRP.

In a thirty-fifth aspect, alone or in combination with one or more of the twenty-seventh aspect through the thirty-fourth aspect, wherein the means for obtaining the identification includes means for identifying an identified TRP of the set of N_{TRP} TRPs as the reference TRP, wherein the identified TRP is identified by a first TCI state of the plurality of TCI states.

In a thirty-seventh aspect, alone or in combination with one or more of the twenty-seventh aspect through the thirty-sixth aspect, wherein the means for obtaining the identification includes means for receiving a downlink control message including an identifier of a TCI state of the plurality of TCI states associated with the reference TRP.

In a thirty-eighth aspect, alone or in combination with one or more of the twenty-seventh aspect through the thirty-seventh aspect, wherein a size of the frequency domain compensation unit is less than a PMI subband by an integer multiple.

In a thirty-ninth aspect, alone or in combination with one or more of the twenty-seventh aspect through the thirty-eighth aspect, wherein the means for determining a plurality of CSI parameters includes means for determining wideband CQI and subband CQI based on the precoder for the one or more reported TRPs compensated by the frequency domain compensation quantity for each frequency compensation unit.

A fortieth aspect may include a non-transitory computer-readable medium having program code recorded thereon. The program code includes program code executable by a computer for causing the computer to determine a plurality of CSI parameters from measurement of one or more channel conditions of CSI-RS received from a set of N_{TRP} TRPs, wherein N_{TRP} corresponds to a number of TRPs within the set of N_{TRP} TRPs; program code executable by the computer for causing the computer to identify a reference TRP of the set of N_{TRP} TRPs; program code executable by the computer for causing the computer to calculate a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP; and program code executable by the computer for causing the computer to transmit a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

In a forty-first aspect, alone or in combination with a fortieth aspect, further including program code executable by the computer for causing the computer to one of: select the fewer than N_{TRP}−1 TRPs as the one or more reported TRPs and exclude non-selected TRPs of the set of N_{TRP} TRPs; or identify one precoder applicable to one reported TRP of the one or more reported TRPs as representative of a group of two or more TRPs of the set of N_{TRP} TRPs having a same delay difference between each of the group of two or more TRPs and the reference TRP.

In a forty-second aspect, alone or in combination with one or more of the fortieth aspect or the forty-first aspect, wherein the program code executable by the computer for causing the computer to identify the reference TRP includes program code executable by the computer for causing the computer to one of: receive a configuration message from a serving network entity, wherein the configuration message identifies the reference TRP; or select the reference TRP having a highest performance characteristic as determined by the computer among the set of N_{TRP} TRPs.

In a forty-third aspect, alone or in combination with one or more of the fortieth aspect through the forty-second aspect, including program code executable by the computer for causing the computer to: generate the CSI report including the CSI parameters with the precoder and the frequency domain compensation quantity for each frequency compensation unit, wherein the CSI report includes a CSI part 1 having a fixed payload size and a CSI part 2 have a variable payload size; quantize the frequency domain compensation quantity for each frequency compensation unit with log₂ Q bits into a quantized frequency domain compensation, wherein (represents a total number of REs for each one of the CSI-RS; and pack the quantized frequency domain compensation into the CSI part 2.

In a forty-fourth aspect, alone or in combination with one or more of the fortieth aspect through the forty-third aspect, wherein the CSI part 2 is packed according to a hierarchical plurality of bit groups, wherein the hierarchical plurality of bit groups include: a first bit group packed into the CSI part 2 first, a second bit group packed into the CSI part 2 second, and a third bit group packed into the CSI part 2 last, and wherein the log₂ Q bits of the quantized frequency domain compensation are packed into one of the first bit group or the second bit group.

In a forty-fifth aspect, alone or in combination with one or more of the fortieth aspect through the forty-fourth aspect, further including program code executable by the computer for causing the computer to: generate the CSI report including the CSI parameters with the precoder and the frequency domain compensation quantity for each frequency compensation unit, wherein the CSI report includes a CSI part 1 having a fixed payload size and a CSI part 2 have a variable payload size; quantize a first designated frequency domain compensation quantity of the frequency domain compensation quantity for each frequency compensation unit associated with a first designated precoder applicable to a first designated TRP of the one or more reported TRPs, wherein the first designated frequency domain compensation quantity is quantized with log₂ Q bits into a quantized first designated frequency domain compensation, wherein Q represents a total number of REs for each one of the CSI-RS; quantize one or more remaining frequency domain compensation quantities of the frequency domain compensation quantity for each frequency compensation unit with a second number of bits into a quantized remaining frequency domain compensation; and pack the quantized first designated frequency domain compensation into the CSI part 1 and the quantized remaining frequency domain compensation into the CSI part 2.

In a forty-sixth aspect, alone or in combination with one or more of the fortieth aspect through the forty-fifth aspect, wherein the first designated frequency domain compensation quantity represents one of a minimum delay or maximum delay of the first designated TRP relative to the reference TRP, and wherein the second number of bits includes one of: log₂ (Q−q₁) bits when the designated frequency domain compensation quantity represents the minimum delay, wherein q represents the frequency domain compensation quantity for the each frequency compensation unit corresponding to the first designated TRP, or log₂ q₁ bits when the designated frequency domain compensation quantity represents the maximum delay.

In a forty-seventh aspect, alone or in combination with one or more of the fortieth aspect through the forty-sixth aspect, further including program code executable by the computer for causing the computer to: identify a TRP index of the first designated TRP; and pack the TRP index into the CSI part 2, wherein the CSI part 2 is packed according to a hierarchical plurality of bit groups, wherein the hierarchical plurality of bit groups include: a first bit group packed into the CSI part 2 first, a second bit group packed into the CSI part 2 second, and a third bit group packed into the CSI part 2, and wherein the TRP index and the second number of bits of the quantized remaining frequency domain compensation are packed into one of the first bit group or the second bit group.

In a forty-eighth aspect, alone or in combination with one or more of the fortieth aspect through the forty-seventh aspect, further including program code executable by the computer for causing the computer to: obtain an identification of the reference TRP; receive a PDSCH scheduled with a plurality of TCI states and having one or more QCL parameters including an average delay or a delay spread; identify the average delay or the delay spread applicable to the reference TRP; and invalidate the average delay or the delay spread as to the each non-reference TRP.

In a forty-ninth aspect, alone or in combination with one or more of the fortieth aspect through the forty-eighth aspect, wherein the program code executable by the computer for causing the computer to obtain the identification includes program code executable by the computer for causing the computer to identify an identified TRP of the set of N_{TRP} TRPs as the reference TRP, wherein the identified TRP is identified by a first TCI state of the plurality of TCI states.

In a fiftieth aspect, alone or in combination with one or more of the fortieth aspect through the forty-ninth aspect, wherein the program code executable by the computer for causing the computer to obtain the identification includes program code executable by the computer for causing the computer to receive a downlink control message including an identifier of a TCI state of the plurality of TCI states associated with the reference TRP.

In a fifty-first aspect, alone or in combination with one or more of the fortieth aspect through the fiftieth aspect, wherein a size of the frequency domain compensation unit is less than a PMI subband by an integer multiple.

In a fifty-second aspect, alone or in combination with one or more of the fortieth aspect through the fifty-first aspect, wherein the program code executable by the computer for causing the computer to determine a plurality of CSI parameters includes program code executable by the computer for causing the computer to determine wideband CQI and subband CQI based on the precoder for the one or more reported TRPs compensated by the frequency domain compensation quantity for each frequency compensation unit.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A user equipment (UE) configured with coherent joint transmission (CJT) multi-transmission-reception point (mTRP) channel state information (CSI) reporting, the UE comprising:
a memory storing processor-readable code; and
at least one processor coupled to the memory, the processor-readable code executable by the at least one processor to cause the UE to:
determine a plurality of CSI parameters from measurement of one or more channel conditions of CSI-reference signals (CSI-RS) received from a set of N_{TRP} transmission-reception points (TRPs), wherein N_{TRP} corresponds to a number of TRPs within the set of N_{TRP} TRPs;
identify a reference TRP of the set of N_{TRP} TRPs;
calculate a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP; and
transmit a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

2. The UE of claim 1, including the processor-readable code executable by the at least one processor to further cause the UE to one of:
select the fewer than N_{TRP}−1 TRPs as the one or more reported TRPs and exclude non-selected TRPs of the set of N_{TRP} TRPs; or
identify one precoder applicable to one reported TRP of the one or more reported TRPs as representative of a group of two or more TRPs of the set of N_{TRP} TRPs having a same delay difference between each of the group of two or more TRPs and the reference TRP.

3. The UE of claim 1, wherein the processor-readable code executable by the at least one processor to cause the UE to identify the reference TRP includes processor-readable code executable by the at least one processor to cause the UE to one of:
receive a configuration message from a serving network entity, wherein the configuration message identifies the reference TRP; or
select the reference TRP having a highest performance characteristic as determined by the UE among the set of N_{TRP} TRPs.

4. The UE of claim 1, including the processor-readable code executable by the at least one processor to further cause the UE to:
generate the CSI report including the CSI parameters with the precoder and the frequency domain compensation quantity for each frequency compensation unit, wherein the CSI report includes a CSI part 1 having a fixed payload size and a CSI part 2 have a variable payload size;
quantize the frequency domain compensation quantity for each frequency compensation unit with log₂ Q bits into a quantized frequency domain compensation, wherein Q represents a total number of resource elements (REs) for each one of the CSI-RS; and
packing the quantized frequency domain compensation into the CSI part 2.

5. The UE of claim 4,
wherein the CSI part 2 is packed according to a hierarchical plurality of bit groups, wherein the hierarchical plurality of bit groups include:
a first bit group packed into the CSI part 2 first,
a second bit group packed into the CSI part 2 second, and
a third bit group packed into the CSI part 2 last, and
wherein the log₂ Q bits of the quantized frequency domain compensation are packed into one of the first bit group or the second bit group.

6. The UE of claim 1, including the processor-readable code executable by the at least one processor to further cause the UE to:
generate the CSI report including the CSI parameters with the precoder and the frequency domain compensation quantity for each frequency compensation unit, wherein the CSI report includes a CSI part 1 having a fixed payload size and a CSI part 2 have a variable payload size;
quantize a first designated frequency domain compensation quantity of the frequency domain compensation quantity for each frequency compensation unit associated with a first designated precoder applicable to a first designated TRP of the one or more reported TRPs, wherein the first designated frequency domain compensation quantity is quantized with log₂ Q bits into a quantized first designated frequency domain compensation, wherein Q represents a total number of resource elements (REs) for each one of the CSI-RS;
quantize one or more remaining frequency domain compensation quantities of the frequency domain compensation quantity for each frequency compensation unit with a second number of bits into a quantized remaining frequency domain compensation; and
packing the quantized first designated frequency domain compensation into the CSI part 1 and the quantized remaining frequency domain compensation into the CSI part 2.

7. The UE of claim 6,
wherein the first designated frequency domain compensation quantity represents one of a minimum delay or maximum delay of the first designated TRP relative to the reference TRP, and
wherein the second number of bits includes one of:
log₂ (Q−q₁) bits when the designated frequency domain compensation quantity represents the minimum delay, wherein q₁ represents the frequency domain compensation quantity for the each frequency compensation unit corresponding to the first designated TRP, or
log₂ q₁ bits when the designated frequency domain compensation quantity represents the maximum delay.

8. The UE of claim 7, including the processor-readable code executable by the at least one processor to further cause the UE to:
identify a TRP index of the first designated TRP; and
pack the TRP index into the CSI part 2, wherein the CSI part 2 is packed according to a hierarchical plurality of bit groups, wherein the hierarchical plurality of bit groups include:
a first bit group packed into the CSI part 2 first,
a second bit group packed into the CSI part 2 second, and
a third bit group packed into the CSI part 2, and
wherein the TRP index and the second number of bits of the quantized remaining frequency domain compensation are packed into one of the first bit group or the second bit group.

9. The UE of claim 1, including the processor-readable code executable by the at least one processor to further cause the UE to:
obtain an identification of the reference TRP;
receive a PDSCH scheduled with a plurality of transmission configuration indication (TCI) states and having one or more quasi-colocation (QCL) parameters including an average delay or a delay spread;
identify the average delay or the delay spread applicable to the reference TRP; and
invalidate the average delay or the delay spread as to the each non-reference TRP.

10. The UE of claim 9, wherein the processor-readable code executable by the at least one processor to cause the UE to obtain the identification includes processor-readable code executable by the at least one processor to cause the UE to identify an identified TRP of the set of N_{TRP} TRPs as the reference TRP, wherein the identified TRP is identified by a first TCI state of the plurality of TCI states.

11. The UE of claim 9, wherein the processor-readable code executable by the at least one processor to cause the UE to obtain the identification includes processor-readable code executable by the at least one processor to cause the UE to:
receive a downlink control message including an identifier of a TCI state of the plurality of TCI states associated with the reference TRP.

12. The UE of claim 1, wherein a size of the frequency domain compensation unit is less than a precoding matrix indicator (PMI) subband by an integer multiple.

13. The UE of claim 12, wherein the processor-readable code executable by the at least one processor to cause the UE to determine a plurality of CSI parameters includes the processor-readable code executable by the at least one processor to cause the UE to:
determine wideband channel quality indicator (CQI) and subband CQI based on the precoder for the one or more reported TRPs compensated by the frequency domain compensation quantity for each frequency compensation unit.

14. A method of wireless communication performed by a user equipment (UE), the method comprising:
determining a plurality of CSI parameters from measurement of one or more channel conditions of CSI-reference signals (CSI-RS) received from a set of N_{TRP} transmission-reception points (TRPs), wherein N_{TRP} corresponds to a number of TRPs within the set of N_{TRP} TRPs;
identifying a reference TRP of the set of N_{TRP} TRPs;
calculating a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP; and
transmitting a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

15. The method of claim 14, further including one of:
selecting the fewer than N_{TRP}−1 TRPs as the one or more reported TRPs and exclude non-selected TRPs of the set of N_{TRP} TRPs; or
identifying one precoder applicable to one reported TRP of the one or more reported TRPs as representative of a group of two or more TRPs of the set of N_{TRP} TRPs having a same delay difference between each of the group of two or more TRPs and the reference TRP.

16. The method of claim 14, wherein the identifying the reference TRP includes one of:
receiving a configuration message from a serving network entity, wherein the configuration message identifies the reference TRP; or
selecting the reference TRP having a highest performance characteristic as determined by the UE among the set of N_{TRP} TRPs.

17. The method of claim 14, further including:
generating the CSI report including the CSI parameters with the precoder and the frequency domain compensation quantity for each frequency compensation unit, wherein the CSI report includes a CSI part 1 having a fixed payload size and a CSI part 2 have a variable payload size;
quantizing the frequency domain compensation quantity for each frequency compensation unit with log₂ Q bits into a quantized frequency domain compensation, wherein Q represents a total number of resource elements (REs) for each one of the CSI-RS; and
packing the quantized frequency domain compensation into the CSI part 2.

18. The method of claim 17,
wherein the CSI part 2 is packed according to a hierarchical plurality of bit groups, wherein the hierarchical plurality of bit groups include:
a first bit group packed into the CSI part 2 first,
a second bit group packed into the CSI part 2 second, and
a third bit group packed into the CSI part 2 last, and
wherein the log₂ Q bits of the quantized frequency domain compensation are packed into one of the first bit group or the second bit group.

19. The method of claim 14, further including:
generating the CSI report including the CSI parameters with the precoder and the frequency domain compensation quantity for each frequency compensation unit, wherein the CSI report includes a CSI part 1 having a fixed payload size and a CSI part 2 have a variable payload size;
quantizing a first designated frequency domain compensation quantity of the frequency domain compensation quantity for each frequency compensation unit associated with a first designated precoder applicable to a first designated TRP of the one or more reported TRPs, wherein the first designated frequency domain compensation quantity is quantized with log₂ Q bits into a quantized first designated frequency domain compensation, wherein Q represents a total number of resource elements (REs) for each one of the CSI-RS;
quantizing one or more remaining frequency domain compensation quantities of the frequency domain compensation quantity for each frequency compensation unit with a second number of bits into a quantized remaining frequency domain compensation; and
packing the quantized first designated frequency domain compensation into the CSI part 1 and the quantized remaining frequency domain compensation into the CSI part 2.

20-26. (canceled)

27. A user equipment (UE) configured with coherent joint transmission (CJT) multi-transmission-reception point (mTRP) channel state information (CSI) reporting, comprising:
means for determining a plurality of CSI parameters from measurement of one or more channel conditions of CSI-reference signals (CSI-RS) received from a set of N_{TRP} transmission-reception points (TRPs), wherein N_{TRP} corresponds to a number of TRPs within the set of N_{TRP} TRPs;
means for identifying a reference TRP of the set of N_{TRP} TRPs;
means for calculating a frequency domain compensation quantity for each frequency domain compensation unit, wherein the frequency domain compensation quantity for each frequency compensation unit compensates a precoder within the CSI parameters applicable to each non-reference TRP of the set of N_{TRP} TRPs and corresponds to a delay difference between the each non-reference TRP and the reference TRP; and
means for transmitting a CSI report including the CSI parameters with the precoder compensated by the frequency domain compensation quantity for each frequency compensation unit, wherein the CSI report includes the precoder applicable to one or more reported TRPs, and wherein the one or more reported TRPs includes fewer than N_{TRP}−1 TRPs of the set of N_{TRP} TRPs.

28-52. (canceled)
